(19) United States
(12) Patent Application Publication
(10) Pub. No.: US 2005/0049843 A1
(43) Pub. Date: Mar. 3, 2005

(54) Computerized extension apparatus and methods

(76) Inventors: Lee Hewitt, Chesham (GB); Mark Farr, Watford (GB); Chao Dong, Bath (CN); Simon Broadley, Aylesbury (GB)

Correspondence Address: GAZDZINSKI & ASSOCIATES, Suite 375, 11440 West Bernardo Court, San Diego, CA, 92127, US

(21) Appl. No.: 10/651,560

(22) Filed: Aug. 29, 2003

(51) Int. Cl. G06F 17/50

(52) U.S. Cl. 703/14

(57) ABSTRACT

Apparatus and methods for integrated circuit (IC) design, including the configuration and addition of extensions to the design. In one exemplary embodiment, a computer program rendered in an object-oriented language implementing the aforementioned methods for automatically adding user-customized extensions to digital processors is disclosed. The program comprises an extension tool which is adapted for varying levels of abstraction, and to significantly automate the creation and generation of various different extension types including for example ALUs, condition codes, and registers. A markup language (e.g., XML) database of abstracted extension components is utilized to permit ready addition and modification of extensions, as well as applicability of the extensions across different target architectures.

### RELATED APPLICATIONS

The present application is related to co-pending U.S. patent application Ser. No. 09/418,663 filed Oct. 14, 1999, entitled “Method And Apparatus For Managing The Configuration And Functionality Of A Semiconductor Design,” which claims priority to U.S. Provisional Patent Application Ser. No. 60/104,271 filed Oct. 14, 1998 of the same title, and co-pending U.S. patent application Ser. No. 10/423,745 filed Apr. 25, 2003, entitled “Apparatus and Method for Managing Integrated Circuit Designs” which claims priority to U.S. Provisional Patent Application Ser. No 60/375,997 filed Apr. 25, 2002 of the same title, all of the foregoing incorporated herein by reference in their entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

The invention relates generally to the field of semiconductor design, and automated design for integrated circuits. More specifically, the invention provides an improved method and apparatus for creating extension components for IC designs described in, inter alia, high level languages.

2. Description of Related Technology

Several types of computer aided design (CAD) tools are available to design and fabricate integrated circuits (IC). Such computer-aided or automated IC design tools can include modules or programs addressing both the synthesis and optimization processes. Synthesis is generally defined as an automatic method of converting a higher level of abstraction to a lower level of abstraction, and can include any desired combination of synthesis techniques which occur at various levels of abstraction. So-called “behavioral synthesis” is a design tool wherein the behavior (e.g. inputs, outputs, and functionality) of a desired IC are entered into a computer program to design a device that exhibits the desired behavior. Such tools permit IC designers to produce increasingly complex and capable devices, sometimes having logic gate counts in the tens of millions, with few or no errors and in a much shorter time period than would be otherwise possible with manual design techniques such as hand layouts.

Examples of synthesis processes which involve different levels of abstraction include architectural level synthesis and logic level synthesis, both of which may be incorporated into the IC design process.

Architectural level synthesis is primarily concerned with the macroscopic structure of the circuit; it utilizes functional blocks (including information relating to their interconnections and internal functionality). Architectural level synthesis includes register transfer level (RTL) synthesis, which can have multi-bit components such as registers and operators.

Logic level synthesis, on the other hand, is concerned with gate level design. Logic level synthesis determines a microscopic structure of a circuit and transforms a logic model into an interconnection of instances of library cells. The result of the logic level synthesis is a netlist of logic devices and their interconnections. Logic-level synthesizers (so-called synthesis “engines”) are available from several commercial vendors.

The synthesis process generally begins with the designer compiling a set of IC specifications based on the desired functionality of the target device. These specifications are then encoded in a hardware description language (HDL) such as VHDL® (VHSIC hardware description language) available from IEEE of New York, N.Y., or Verilog® available from Cadence Design Systems, Inc. of Santa Clara, Calif. The specifications define an IC in terms of the desired inputs and outputs, as well as desired functionality such as available memory or clock speed. From the HDL, the designer then generates a “netlist” including a list of gates and their interconnections, which is descriptive of the circuitry of the desired IC. Ultimately, the design is compiled and masks fabricated for producing the physical IC. See, e.g., U.S. Pat. No. 6,324,678 to Dangelo, et al. issued Nov. 27, 2001 and entitled “Method and system for creating and validating low level description of electronic design”, which discloses a methodology for generating lower-level structural descriptions of complex digital devices from higher-level descriptions and specifications.

As IC design technologies have matured over the years, significant efforts have been made to make the design process more intuitive and accessible. These efforts have spawned a variety of behavior synthesis or design tools operating at higher levels of abstraction as compared to the aforementioned logic synthesis tools (which are targeted at lower levels of the design process). These high-level tools are typically focused on so-called user-configurability; i.e., providing a user/designer the ability to easily and rapidly generate an IC (e.g., processor) design embodying all of their specific desired features and functionality. The ARChitect™ design environment (software) produced by the Assignee hereof exemplifies the current state of the art in user-configurable IC design tools; see the discussion of WIPO Publication No. WO0022553 provided subsequently herein, which is directed to the fundamental properties of a user-configurable processor design tool.

Extensibility

Key in the efficacy of these high-level design tools is the ability to add to or extend the existing processor hardware configuration. Generally, hardware IP designs can be extended in a number of different ways. For example, for processor IP cores such as the ARCtangent™ core developed and sold by the Assignee hereof, the hardware IP design can be extended by adding IP components such as instructions, core registers, memory mapped registers, or peripheral components. During the design process, designers may integrate their extension component into a software library which maintains descriptions of several extension components.

Various approaches to extending processor hardware have been proposed. One such approach is disclosed in U.S. Pat. No. 4,763,242 to Lee, et al. issued Aug. 9, 1988, entitled “Computer providing flexible processor extension, flexible instruction set extension, and implicit emulation for upward software compatibility,” which describes a computer system and associated instruction set which allow for instruction set extension, and so-called “assists” (hardware which extends the processor's capability). The “processor” of Lee, however, is distributed across several discrete components, and in no way provides for user-configurability high-level abstraction during the design of any of the components.

U.S. Pat. No. 6,389,528 to Pappalardo, et al., issued May 14, 2002, entitled “Processor with a control instruction for sending control signals without interpretation for extension of instruction set,” discloses a processor with a set of instructions comprising an operation section and an operand section. For a special control instruction, the operand section is transmitted to the operation blocks along a bypass path separate from the normal path in which normal instructions are interpreted. In this way, an extension of the set of instructions can be achieved for tailoring the set of instructions to the user's own requirements. Similar to Lee above, however, Pappalardo in no way provides for user-configurability high-level abstraction during processor design.

U.S. Pat. No. 6,032,253 to Cashman, et al. issued Feb. 29, 2000 and entitled “Data processor with multiple compare extension instruction” discloses a programmable data communications device to process multiple streams of data according to multiple protocols. The device is equipped with a co-processor including multiple, programmable processors having extended instruction sets including instructions providing the operations of zero stuffing, CRC computation, partial compare, conditional move, and trie traversal. These instructions allow the processor(s) of the co-processor to more efficiently execute programs implementing data communications protocols. Since each processor is programmable, protocols standards which change may be accommodated. No mechanisms for user configurability or extensibility are provided, however. See also U.S. Pat. Nos. 6,175,915 and 6,065,027.

WIPO Publication No. WO0022553 published Apr. 20, 2000 and entitled “Method And Apparatus For Managing The Configuration And Functionality Of A Semiconductor Design” discloses a fundamental method of managing the configuration, design parameters, and functionality of an integrated circuit (IC) design using a hardware description language (HDL) in the context of a user-operated design environment. Instructions can be added, subtracted, or generated by the designer interactively during the design process, and customized HDL descriptions of the IC design are generated through the use of scripts based on the user-edited instruction set and inputs. The customized HDL description can then be used as the basis for generating “makefiles” for purposes of simulation and/or logic level synthesis. The method further affords the ability to generate an HDL model of a complete device, such as a microprocessor or DSP. A library mechanism for different types of extensions is also provided.

Hardware/Software Co-Design

Yet another approach to processor design and testing is generally referred to as hardware/software (HW/SW) co-design. This approach generates a processor design as well as one or more tools (e.g., assemblers, compilers, simulators, etc.) that are in some respects specific to the generated (and customized) hardware design. Changes to the hardware design generally dictate a change to the software tools as well.

For example, U.S. Pat. No. 5,949,993 to Fritz issued Sep. 7, 1999 and entitled “Method for the generation of ISA simulators and assemblers from a machine description” discloses a method for generating software development tools to be used in hardware and software development. The invention is utilized by processing a hardware description and a syntax description of programmable electronics, such as a microprocessor, and generating a set of development tools useful to a hardware and/or software developer. Some of these tools include, for example, simulators, assemblers, decoders, disassemblers, behavior semantics, and attribute grammars.

U.S. Pat. No. 6,477,683 to Killian, et al. issued Nov. 5, 2002 and entitled “Automated processor generation system for designing a configurable processor and method for the same”, describes an automated processor design tool. The tool includes a description of customized processor instruction set extensions in a standardized language to develop a configurable definition of a target instruction set, a Hardware Description Language description of circuitry necessary to implement the instruction set, and development tools such as a compiler, assembler, debugger and simulator which can be used to develop applications for the processor and to verify it. Implementation of the processor circuitry can be optimized for various criteria such as area, power consumption, speed and the like. Once a processor configuration is developed, it can be tested and inputs to the system modified to iteratively optimize the processor implementation.

However, the “description” language taught in the '683 patent referenced above (TIE or Tensilica Instruction Extension language) is complicated and is limited in the types of instructions which it can define. In contrast, by defining an instruction in HDL as opposed to TIE/TIE2, one has complete control over the HDL constructs being used, so therefore also control over synthesis, including the ability to infer or instantiate components for synthesis tools to get the best possible implementation.

Similarly, U.S. Pat. No. 6,477,697 to Killian, et al. issued Nov. 5, 2002 and entitled “Adding Complex Instruction Extensions Defined In A Standardized Language To A Microprocessor Design To Produce A Configurable Definition Of A Target Instruction Set, And HDL Description Of Circuitry Necessary To Implement The Instruction Set, And Development And Verification Tools For The Instruction Set” also discloses an automated processor design tool. The standardized language disclosed in this patent is capable of handling instruction set extensions which modify processor state or use configurable processors.

In addition to the foregoing, numerous distinct behavioral (e.g., instruction set) and structural descriptions of the processor have been proposed in the context of HW/SW co-design. See, e.g., “EXPRESSION: An ADL for System Level Design Exploration,” Technical Report No. 98-29, dated September 1998, and “LISA—Machine Description Language and Generic Machine Model for HW/SW Co-Design,” Zivojnovic, et al., October 1996. See also “ISDL: An Instruction Se Description Language for Retargetability”, Hadjiyiannis, et al., DAC, 1997. The Cadence nML language is also of note; see “Hartoog, et al, “Generation of Software Tools From Processor Descriptions for Hardware/Software Codesign,” ACM, June 1997, pp. 303-306.

A somewhat similar co-design approach is described in “Retargetable Code Generation based on Structural Processor Descriptions”, Leupers, et al., Design Automation for Embedded Systems, vol. 3, no. 1, January 1998, which describes the MIMOLA/TREEMOLA design language and tool suite. The MIMOLA approach is generally more akin to a hardware description language (such as for example VHDL) than the Expression, nML, LISA, or ISDL approaches, which are to a large extent geared toward cycle-accurate behavior (instruction) modeling.

Deficiencies of the Prior Art

Despite the wide variety of approaches to processor design present in the prior art, such approaches generally have one or more salient weaknesses, especially in the context of facilitating the addition of extension components to the target design by a user.

First, when adding extension components to existing hardware IP, it is common that the extension itself may be well understood by the designer, but the interface to the existing hardware may by complex, and not easily understood. This is especially true when designing efficient interfaces for custom extension instructions in processor designs.

Second, tools that attempt to help create extension hardware have to balance between simplifying the automation process to make it usable and accessible (especially for creating simple extensions), yet allowing enough functionality for creating complex extensions when required. This normally means that either the complexity of extensions is limited, or the automation is too complex, making the creation of extensions difficult and non-intuitive.

Third, extension components are usually designed to interface to a pre-defined target architecture, such as a specific processor core or variant. An extension component, such as an extension instruction, designed for one processor core, will not be compatible with any other processor cores.

Fourth, hardware IP is modeled in different languages, usually description languages (e.g., HDL) are used for defining synthesizable models, and C/C++ is used for defining behavioral models. If a common language is used for creating the extension IP component, then the functionality is usually restricted, and the implementation will not be optimal because of the additional language conversion process. This also makes it difficult to support new modeling languages.

Fifth, hardware IP models are often implemented with several different architectural models, using different levels of abstraction. For example, a simulation model may be instruction-accurate or cycle-accurate, and a hardware model may use behavioral HDL or synthesis HDL. The prior art systems previously described herein generally cannot support different architectural models and models with different levels of abstraction.

Sixth, hardware IP designs can be extended in a number of different ways, such as by adding instructions, core registers and memory mapped registers for processor IP cores. Generally, the extension of hardware IP is restricted to a limited number of interfaces types, due to the complexity of supporting different extension types.

Finally, when hardware extensions are created, in addition to the model being created, there are a number of other aspects of design implementation that must be considered. For example, the hardware extension will require verification, documentation, and possibly synthesis scripts. Processor extensions may require assembler and compiler extension and support files. Common prior art approaches rely on separate mechanisms for generating the simulation models and support files, thereby resulting in inefficiencies and potentially incompatibilities.

Based on the foregoing, there is a significant need for improved methods and apparatus for extending an integrated circuit (e.g., processor) design. Ideally, such improved methods and apparatus would (i) facilitate implementation of new extensions, (ii) permit porting of the extensions on various similar or heterogeneous platforms or architectures, and (iii) support different types of simulation models and other development tools. Such improved solutions would also ideally be easy to use, flexible in their level of complexity and abstraction, and broadly adaptable to a number of different modeling languages.

### SUMMARY OF THE INVENTION

The present invention satisfies the aforementioned needs by providing an automated means of managing and extending the configuration of an integrated circuit design, through the use of an interactive computer program.

In a first aspect of the invention, a computerized processor design tool adapted to permit the addition of user-configured extensions useful across multiple heterogeneous target architectures is disclosed. In one exemplary embodiment, the extensions comprise abstracted language (e.g., XML) representations which each reference at least one native target architecture template.

In a second aspect of the invention, a computerized processor design tool adapted to permit the addition of a user-configured extension using variable levels of design abstraction is disclosed. In one exemplary embodiment, three levels of abstraction are provided: (i) a high level of abstraction, wherein hardware associated with the extension is automatically implemented based on UI inputs from the user; (ii) an intermediate level of abstraction, wherein at least a first portion of the extension is implemented according to a UI definition, and a simplified extension interface is provided to the user to allow custom functionality to be created thereby; and (iii) a low level of abstraction, wherein all internal signals associated with the extension are provided to the user via a user interface (UI), the UI allowing a complex customized extension to be created by the user.

In a third aspect of the invention, a computerized tool for extending integrated circuit designs is disclosed, generally comprising at least one abstracted and user-configured extension component definition rendered in a markup language, the component definition referencing at east one structure rendered in a native language. In one exemplary embodiment, the markup language comprises extensible markup language (XML), and the structure comprises a template rendered in hardware description language or a behavioral language.

In a fourth aspect of the invention, a method of generating an extension component for use with a computerized processor design is disclosed, the method generally comprising: selecting at least one extension type from a plurality of types, the extension type comprising an extension definition rendered in a first language; obtaining logic from a user regarding the desired functionality of the extension; referencing at least one extension template rendered in a second language; and generating the extension component based at least in part on the extension definition, user logic, and the extension template. In one exemplary embodiment, the extension component is stored within a database rendered substantially in XML.

In a fifth aspect of the invention, an improved extension component useful with a computerized design of a digital processor is disclosed, the component comprising; at least one extension template adapted to generate control logic for at least one extension type; at least one extension test template adapted to permit testing of said extension component; and user provided extension logic describing at least a portion of the functionality of said extension component. In one exemplary embodiment, the extension component further comprises user provided extension test code and component integration files, and the control logic comprises control logic for instances of (i) extension ALUs, (ii) condition codes, and (iii) extension registers.

In a sixth aspect of the invention, an improved method of generating an extension component for use with a computerized processor design is disclosed, the method generally comprising: selecting at least one extension type for use with the extension component; selecting a plurality of configuration options associated with the at least one extension type; generating at least one template based at least in part on the acts of selecting; generating a custom interface based at least in part on the at least one template; obtaining logic via the custom interface; and combining the logic and template(s) to produce the extension component.

In a seventh aspect of the invention, an improved computerized tool for extending integrated circuit designs is disclosed, the tool generally comprising at least one abstracted and configurable extension component definition rendered in a universal language, the component definition being adapted to reference at least individually a plurality of structures each rendered in a different native language. In an exemplary embodiment, at least one of the structures is associated with a target architecture which does not yet exist; hence, the tool is advantageously made “forward compatible” with literally any new target architecture which may be developed in the future, so long as a template (interface) is available for that architecture.

In an eighth aspect of the invention, a method of doing business is disclosed, the method generally comprising: providing a design environment, and extension tool compatible with the design environment, to at least one customer; and providing processor instructions to the at least one customers in a predetermined format adapted for use with the extension tool and design environment. In one exemplary embodiment, the format comprises predetermined or reserved opcodes.

In a ninth aspect of the invention, an improved computerized tool adapted to efficiently extend integrated circuit designs is disclosed, the tool generally comprising at least one abstracted and configurable extension component definition rendered in a universal language, the component definition being adapted to generate support files. In one embodiment, the support files consist of one or more of (i) test hardware support files; test software support files; and (iii) assembler/compiler support files. Automated provision of such files advantageously reduces the extension (and processor design) generation and test cycle.

In a tenth aspect of the invention, an improved computerized system for generating a processor design is disclosed, the system generally comprising: a computerized parent design environment; an extension tool adapted to operate with the environment, the tool adapted to generate an extension component by: (i) selecting at least one extension type for use with the extension component; (ii) selecting a plurality of configuration options associated with the extension type(s); (iii) generating at least one template based at least in part on the aforementioned selection; (iv) generating a user interface based at least in part on the template(s); (v) obtaining logic via the user interface; and (vi) combining the logic and template(s) to produce the extension component. In an exemplary embodiment, the design environment comprises an object-oriented environment adapted to run on a computer, and the available extension types comprise at least one of an ALU, condition code, auxiliary register, or core register. The extension component and template(s) are rendered in a markup language; a markup language database adapted to store them is also provided as part of the system.

### BRIEF DESCRIPTION OF THE DRAWINGS

FIG. 1 is a logical flow diagram of the generalized methodology of extending a design according to the present invention.

FIG. 2 is a graphical representation of an exemplary embodiment of the method used to abstract model interfaces associated with the design.

FIG. 2a is a graphical representation of an exemplary GUI generated from an extension definition which allows multiple instances of the extension.

FIG. 3 is a graphical flow diagram illustrating an exemplary design tool (i.e., ARChitect) implementation of the extension components (interfaces) of FIG. 2.

FIG. 4 is a graphical representation of a user interface (GUI) generated by the design tool of FIG. 3.

FIG. 5 is a graphical representation of an exemplary context-sensitive editor GUI according to the invention, showing an example custom extension implementation in VHDL.

FIG. 6 is a graphical representation of an exemplary design environment GUI showing a sample extension component being added to a circuit design.

FIG. 7 is a graphical representation of a design environment GUI that combines the extension component data into the system displays.

FIG. 8 is a graphical representation of one embodiment of an extension component disposed within a design environment (e.g., ARChitect) IP library according to the present invention.

FIG. 9 is a logical block diagram illustrating an exemplary interface between an extension ALU template and the ALU extension logic provided by users (including the signal set provided to the processor core).

FIG. 10 is a logical block diagram illustrating an exemplary hardware interface between the extension condition code (cc) template and users.

FIG. 11 is a logical block diagram illustrating an exemplary extension core register interface according to the invention.

FIG. 12 is a schematic diagram illustrating exemplary template logic for the extension core register.

FIG. 13 is a logical block diagram illustrating an exemplary interface of the auxiliary register extension template.

FIG. 14 is a schematic diagram illustrating exemplary template logic for the extension auxiliary register.

FIG. 15 is a logical representation of the extension tool, demonstrating exemplary signal propagation through the components within the scope of the tool.

### DETAILED DESCRIPTION

Reference is now made to the drawings wherein like numerals refer to like parts throughout.

As used herein, the terms “computer program,” “routine,” “subroutine,” and “algorithm” are essentially synonymous, with “computer program” being used typically (but not exclusively) to describe collections or groups of the latter three elements. Such programs, routines/subroutines, and algorithms may be rendered in any language including, for example, an object-oriented language. In general, however, all of the aforementioned terms as used herein are meant to encompass any series of logical steps performed in a sequence to accomplish a given purpose.

As used herein, the term “IP” generally refers to intellectual property which includes, without limitation, IC designs, methods, processes, schematics, code, hardware description language models, configurations (“builds”), scripts, logic level representations, and software objects and components (and their descriptions), which may be used or generated by an individual or system.

As used herein, the term “IP library” generally refers to a repository for the definitions of IP components. Such repository may be of literally any form which is accessible to one or more users.

As used herein, the terms “extension” and “extension component” generally refer to one or more logical functions and/or components which can be selectively configured and/or added to an IC design. For example, extensions may comprise an extension instruction (whether predetermined according to a template, or custom generated/configured by the designer) such as rotate, arithmetic and logical shifts within a barrel shifter, MAC functions, swap functions (for swapping upper and lower bytes, such as for Endianess), timer interrupt, sleep, FFT, CMUL, CMAC, XMAC, IPSec, Viterbi butterfly, and the like. Extensions may also include features or components such as multiplier/arithmetic units, functional units, memory, scoreboards, and any number of other features over which a designer may desire to exert design control.

As used herein, the term “extension tool” generally refers to a software tool or module that enables the automated generation and/or configuration of extensions.

Any references to description language (DL), hardware description language (HDL) or VHSIC HDL (VHDL) contained herein are also meant to include other hardware description languages such as Verilog®, VHDL, Systems C, Java®, CAS, ISS, or any other programming language-based representation of the design, as appropriate. Furthermore, an exemplary Synopsys® synthesis engine such as the Design Compiler may be used to synthesize the various embodiments set forth herein, or alternatively other synthesis engines such as Buildgates® available from Cadence Design Systems, Inc., may be used. IEEE Std. 1076.3-1997, IEEE Standard VHDL Synthesis Packages, describes an industry-accepted language for specifying a Hardware Definition Language-based design and the synthesis capabilities that may be expected to be available to one of ordinary skill in the art.

As used herein, the term “processor” is meant to include any integrated circuit or other electronic device (or collection of devices) capable of performing an operation on at least one instruction word including, without limitation, reduced instruction set core (RISC) processors such as for example the ARC Ax and ARClite family of user-configurable cores provided by the Assignee hereof, central processing units (CPUs), ASICs, and digital signal processors (DSPs). The hardware of such devices may be integrated onto a single substrate (e.g., silicon “die”), or distributed among two or more substrates. Furthermore, various functional aspects of the processor may be implemented solely as software or firmware associated with the processor.

As used herein, the term “markup language” refers to any member of the markup language family, including without limitation XML, XSL, SGML, HTML, VoXML, MathML, SMIL, SVG, VML, XHTML, and the many variants thereof. For example, XML refers to Extensible Markup Language, a markup language for documents containing structured information and developed by the World Wide Web Consortium (W3C), including XML 1.0, XML 1.0 (Second Edition), and XML 1.1.

Additionally the term “stage” as used herein refers to various successive stages within a pipelined processor; i.e., stage 1 refers to the first pipeline stage, stage 2 to the second pipeline stage, and so forth. Such stages may comprise, for example, instruction fetch, decode, execution, and writeback stages.

The term “user logic” refers generally to any description language and/or other components (e.g., test code) that are supplied by the user as additions into a standard component structure or template.

Lastly, the term “user interface” (UI) refers to any mechanism by which one or more users or other information sources may communicate information between themselves and the extension tool. Such interfaces may include, for example, a graphical user interface (GUI), an auditory interface (AUI), a tactile interface (such as for example a display adapted for capacitive or other “touch” activation), an optical (retinal) interface, and the like, all of which are well known to those of ordinary skill in the relevant art. Such interfaces may also include automated or computerized interfaces to information or data sources such as databases, algorithms, and networked devices, each of the latter adapted to receive requests for information from the extension tool, and provide the requested data thereto. Hence, while described in the context of a user (human) operated computer program, it will be appreciated that the fundamental aspects of the invention may be implemented in an entirely or almost entirely automated fashion.

Overview

The present invention provides, inter alia, a method and apparatus particularly adapted for creating, developing, and implementing extension components for hardware IP designs to produce structures or other output such as a standard IP library component. The invention makes it very simple for designers or end users to implement a new extension, while simultaneously supporting a comparatively high level of extension complexity if desired.

In one exemplary variant, the invention comprises a software entity or module (extension tool) which automatically generates the standard extension code used to produce various extension types (e.g., ALU extensions, core register extensions, auxiliary register extensions, and condition code extensions), so that the user need only supply the logic that is specific to their particular implementation.

The extensions of the present invention also each support a number of varying configurations. The user selects a number of configuration options for the extension type that is required. The selected configuration is used to create a number of instruction templates which implement the basic extension functionality. Custom logic is then added to the extension according to an interface that is defined by the templates (and presented in the extension tool). The templates and the custom logic are then combined to make a new extension component. Advantageously, templates may be provided for a variety of different languages and tools including e.g., VHDL®, Verilog®, CAS, ISS (including providing test code and assembler support), so as to make the implementation both as flexible and complete as possible. The “customized” behavioral and structural languages of the prior art previously described herein (e.g., LISA, nML, EXPRESSION, MIMOLA, TIE, and the like) may also be used as the basis of templates or other structures consistent with present invention, such as by for example adding an extra compile phase (e.g., TIE to HDL).

Additionally, the invention simplifies the creation of custom IP extensions by abstracting the complex interface(s) associated therewith, thereby allowing for much simplified interfaces. The hardware IP required between the abstracted layers is then automatically generated according to the pre-defined templates or other data structures that are controlled by the designer. The use of different levels of abstraction advantageously allows different levels of complexity to be exposed to the user. At the highest level of abstraction, the hardware is implemented completely automatically from a user interface (e.g., GUI) definition. With the next level of abstraction, some of the design is implemented according to the UI definition, and a simplified interface is exposed to the user to allow the designer/user to create customized IP. At the lowest level of abstraction, all (or substantially all) internal signals are exposed to allow any complex extension to be created by the user. The GUI controls the amount of exposed logic, allowing multiple levels of abstraction to be exposed between these fundamental levels. When operating at a high level of abstraction, the user is advantageously freed from the need to implement control logic, allowing them to focus on the ALU functionality

Because this invention optionally abstracts the extension interface to a higher level, and generates the interface logic for the target architecture from a number of templates (or other structures), an extension component generated with the invention is not restricted to any particular target architecture. Literally any target architecture can be used as long as the interface templates/structures are provided. This advantageously permits extension components to be shared between similar target architectures, such as for example sharing extension instruction components for an ARCtangent-A4 and an ARCtangent™ A5 processor. This feature also extends to dissimilar architectures; for example, ARCtangent™ A5 and Tensilica® Xtensa® processor architectures may share extension components using the present invention.

In the exemplary embodiment, the abstracted extension components are defined in a markup language (e.g., XML), which references the templates or other structures that are rendered in their native language. Therefore, new extension component templates/structures and source files can be added without the need for modifying the tools that reference them. The extension components are therefore substantially “universal” in nature. This feature makes it quite easy to add new extension components, as well as to extend the functionality of existing extension components.

A further advantage of the technique of abstracting the custom interfaces into separate templates as previously described is that if the target architecture changes, only the abstracted extension templates need to be modified to take the change into account, rather than the more substantial modification required under the prior art. The extension components available in the markup language database of the present invention do not need to be modified. Additionally, the target architecture does not even need to exist when the custom extension(s) is/are created. When new target architectures are developed, the abstracted templates can be implemented for the new target architecture, so that all existing extension components will be compatible with the new architecture. Hence, the extension technique afforded by the present invention is in effect “forward compatible” with all future target architectures so long as templates for that architecture can be provided. The abstracted extension component templates may also be stored independent of the extension component; hence, only the abstracted templates need to be changed to integrate the custom extension with different target architectures.

However, since, the abstracted templates and custom components are in the same format, they can also be incorporated together (“bundled”) into a single component implementation. This approach makes the extension specific to a particular target architecture, yet advantageously allows for modification of the lower level template implementations to permit more complex and highly optimized designs to be created.

As previously described, data common between language implementations is abstracted into a markup language database, thereby allowing language-specific template interfaces to be used for each supported language. This feature optimizes the implementation of the invention in existing design environments, and also readily integrates new modeling languages by allowing for the creation of new interface templates. Different architectural models, and models with different levels of abstraction, are each supported by providing template interfaces in the appropriate style.

Furthermore, the invention permits the user to define the interfaces and type of extensions separately. This feature makes the invention capable of supporting any extension type, using a common mechanism for defining the different extensions.

Support for the delivery of instructions in a desired format is also provided. The exemplary extension tool module of the present invention allows instructions to be delivered to end users or customers in a format using designated or reserved opcodes if desired. Specifically, in the exemplary embodiment, since there are a limited number of extension opcode locations available, some opcodes have been defined that are available to the user, and some are reserved for other purposes (e.g., future expansion, etc.). This approach advantageously assures that user opcodes do not clash with other (manufacturer or reserved) opcodes. The exemplary extension tool disclosed herein allows the user to choose their own opcode from the ‘user allocated’ opcodes via a UI which then automatically proliferates throughout the extension implementation, making it very easy to change the opcode. Manufacturer or reserved designed extensions use the reserved allocated opcode values, so that they never clash with user opcodes.

Finally, the mechanisms used in the invention to generate the simulation models are capable of generating (whether automatically, semi-automatically, or manually under user control) any form of support file, such as test hardware and software, and assembler/compiler support files. This is particularly advantageous since when hardware extensions are created, a number of other aspects of design implementation must be considered in addition to the extension model being created. For example, the hardware extension will require verification, documentation and possible synthesis scripts. Processor extensions may require assembler and compiler extension and support files. The ability of the invention to generate these additional components significantly decreases development time.

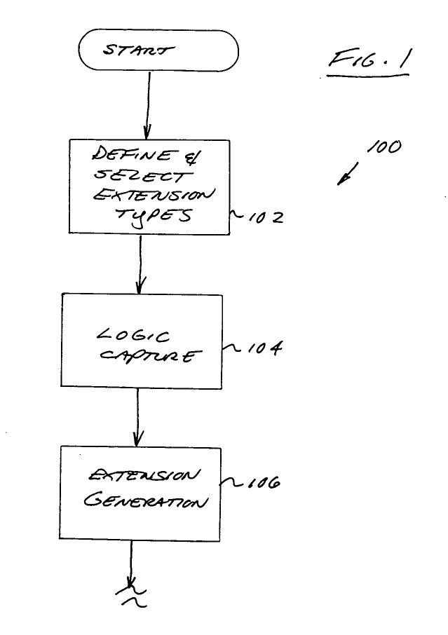

Referring now to FIG. 1, the basic methodology of the extension generation process according to the present invention is described. It will be appreciated that the process 100 of FIG. 1 is a generalized representation of the more complicated process described in greater detail subsequently herein.

As shown in FIG. 1, the extension process 100 fundamentally comprises three different stages or steps, namely (i) extension type definition and selection 102; (ii) logic capture 104; and (iii) extension generation 106.

As used herein, the term “extension type” generally refers to information that determines the configuration of an extension. Examples of extension types include arithmetic logic unit (ALU), Condition Code, Core Register, and Auxiliary Register extension types, although others may readily be specified. Extension types according to the present invention are effectively configurable templates, and are IP “components” like any other configuration template. Table 1 shows an exemplary extension type definition according to the invention.

TABLE 1

| Type | Options | Values |
|---|---|---|
| ALU | Name | <string> |
| | Code Size | 16 bits, 32 bits |
| | Operands | Zero, Single, Dual |
| | Execution Cycles | Integer |
| | Writeback | Yes, No |
| | Flag (.F suffix | Yes, No |
| | in assembler) | |
| Condition | Assembler suffix Name | <string> |
| Code | Value | Integer |
| Core | Name | <string> |
| Register | Access | Read, Read & Write |
| Auxiliary | Name | <string> |
| Register | Access | Read, Write, Read & Write |
| | Dual Access | Yes, No |
| | Dual Access behaviour | Hold Host, Stall Processor |

Note:
Values for the opcodes and register address may also be required, and registers are scoreboarded automatically where necessary.

Each of the extension types of Table 1 can be instantiated multiple times. For example, an extension can contain multiple instructions (of the same or different type), with multiple condition codes and registers. Extension types are defined as individual IP components. This way each type can have, inter alia, its own set of options and its own set of file lists and variables. The extension types can also be added into a parent component.

Obtaining the information required for each extension type per step 102 is accomplished by informing the extension tool which templates are required to be to pulled into the component; a “skeletal” extension is then created, to which the user can then add their own custom logic to complete the extension (step 104 described below).

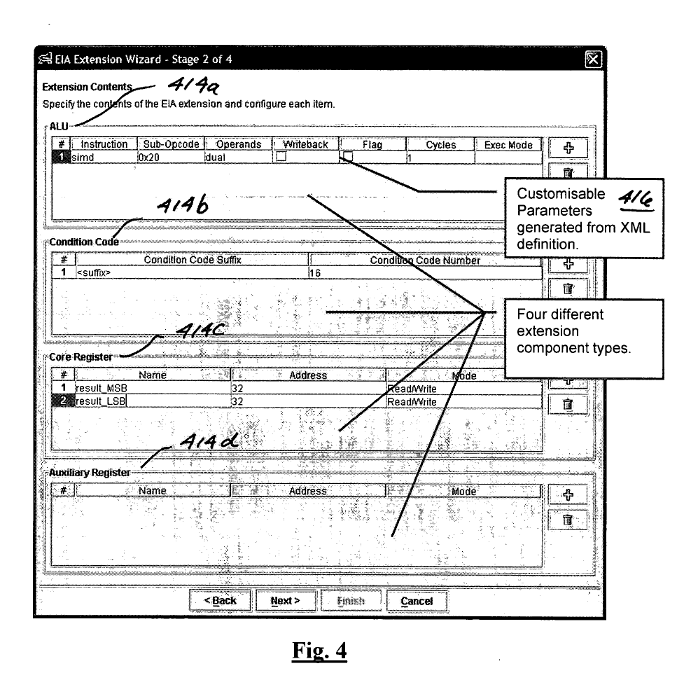

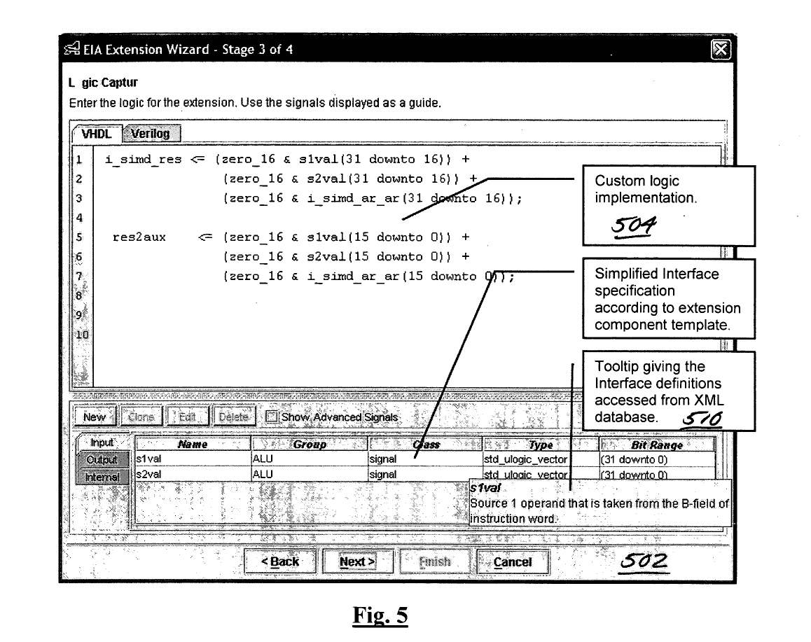

The logic capture step 104 is fundamental to the extension component addition process. It determines how the extension types, defined in the step 102, are actually utilized; In the exemplary embodiment, a GUI editor (see FIG. 5) is used in the logic capture process. The GUI editor and supporting capture process are designed to (i) show the available input, output and internal signals to the user; (ii) allow the user to add internal declarations; e.g., libraries and packages; (iii) allow the user to add extra inputs/outputs to/from the new extension; (iv) capture the extension logic from the user; and (v) permit the addition of more levels of hierarchy. These features are described in greater detail subsequently herein.

Lastly, in step 106, the extension component is generated (in the form of a typical IP component in an IP Library in the exemplary embodiment). Two variants of the component being created are possible: (i) “minimal”; and (ii) complete.

In the minimal configuration, the information stored in the component comprises the references to the templates in a common directory. This approach allows changes/bug fixes to the template to ripple through all future builds without requiring changes to the individual extensions. The components generated this way are processor independent, and can be used with any processors without any changes.

Under the “complete” option, the information stored in the component comprises the complete extension with all HDL added, and is not be dependent on any templates. This approach allows the user to modify all generated code, but in doing so breaks compatibility with the software extension tool (i.e., the extension could not be loaded back into the tool). This approach also makes the extension processor-specific. This approach also allows the creation of IP suitable for distribution to end users, and permits the extension tool to be used as a starting point to implement more complex instructions that are not supported by the tool itself.

Additional details on IP component creation and storage are provided subsequently herein.

### EXEMPLARY EMBODIMENTS

The various aspects and features of the invention are now described in detail in the context of certain exemplary embodiments. It will be appreciated that while the following exemplary embodiments are cast generally in terms of the ARCtangent™ A5 processor, the ARCompact™ ISA, and existing object-oriented design environment described in U.S. patent application Ser. No. 10/423,745 filed Apr. 25, 2003, entitled “Apparatus and Method for Managing Integrated Circuit Designs” previously incorporated herein (hereinafter generally referred to as “ARChitect 2™”), the various aspects of the invention are in no way limited to such processor or environment (or any particular programming paradigm), and may be utilized in any number of different applications, the following merely being illustrative of the broader principles of the invention. Adaptation of the invention to such other applications can be readily accomplished by those of ordinary skill given the disclosure provided herein, and accordingly is not described further herein.

The ARCtangent processor is a user-customizable 32-bit RISC core for ASIC, system-on-chip (SoC), and FPGA integration. It is synthesizable, configurable, and extendable, thus allowing developers to modify and extend the architecture to better suit specific applications. The processor comprises a 32-bit RISC architecture with a four-stage execution pipeline. The instruction set, register file, condition codes, caches, buses, and other architectural features are user-configurable and extendable. It has a 32×32-bit core register file, which can be doubled if required by the application. Additionally, it is possible to use large number of auxiliary registers (up to 2E32). The functional elements of the core of this processor include the arithmetic logic unit (ALU), register file (e.g., 32×32), program counter (PC), instruction fetch (i-fetch) interface logic, as well as various stage latches.

ARCompact™ comprises an instruction set architecture (ISA) that allows designers to mix 16 and 32-bit instructions on its 32-bit user-configurable processor. The key benefit of the ISA is the ability to cut memory requirements on a SoC (system-on-chip) by significant percentages, resulting in lower power consumption and lower cost devices in deeply embedded applications such as wireless communications and high volume consumer electronics products.

The main features of the ARCompact ISA include 32-bit instructions aimed at providing better code density, a set of 16-bit instructions for the most commonly used operations, and freeform mixing of 16- and 32-bit instructions without a mode switch—significant because it reduces the complexity of compiler usage compared to competing mode-switching architectures. The ARCompact instruction set expands the number of custom extension instructions that users can add to the base-case ARCtangent™ processor instruction set. With the ARCompact ISA, users can add literally hundreds of new instructions. Users can also add new core registers, auxiliary registers, and condition codes. The ARCompact ISA thus maintains and expands the user-customizable and extensible features of ARC's extensible processor technology.

As 32-bit architectures become more widely used in deeply embedded systems, code density can have a direct impact on system cost. Typically, a very high percentage of the silicon area of a system-on-chip (SoC) is taken up by memory.

The ARCompact ISA delivers high density code helping to significantly reduce the memory required for the embedded application. In addition, by fitting code into a smaller memory area, the processor potentially has to make fewer memory accesses. This can cut power consumption and extend battery life for portable devices such as MP3 players, digital cameras and wireless handsets. Additionally, the shorter instructions can improve system throughput by executing in a single clock cycle some operations previously requiring two or more instructions. This can boost application performance without having to run the processor at higher clock frequencies.

The support for freeform use of 16 and 32-bit instructions allows compilers and programmers to use the most suitable instructions for a given task, without any need for specific code partitioning or system mode management. Direct replacement of 32-bit instructions with new 16-bit instructions provides an immediate code density benefit, which can be realized at an individual instruction level throughout the application. As the compiler is not required to restructure the code, greater scope for optimizations is provided, over a larger range of instructions. Application debugging is more intuitive because the newly generated code follows the structure of the original source code.

The ARCompact ISA is described in greater detail in co-pending U.S. patent application Ser. No. 10/356,129 entitled “Configurable Data Processor With Multi-Length Instruction Set Architecture” filed Jan. 31, 2003, assigned to the Assignee hereof, and incorporated by reference herein in its entirety.

Accordingly, the exemplary embodiment of the present invention supports a variety of different extension instruction configurations, including (i) 16-bit single/dual operands; (ii) 16-bit single/multiple cycles; (iii) 32-bit single/dual operands; and (iv) 32-bit single/multiple cycles. Both pipelined and stalled multi-cycle instructions are supported. Register scoreboarding is also provided for multi-cycle extension instructions Features of the exemplary embodiment of the extension tool include (i) GUIs for authoring and configuration; (ii) editing/cloning/cutting and pasting IP within the tool; (iii) “correct by construction” rule checking functionality built into the extension at the authoring stage; (iv) automated generation of documentation (built during the authoring stage, configured then output at build time); (v) automated integration of additional components required by the module (e.g., interrupts, registers, scoreboarding, etc.) with conflict checking; (vi) automated test bench/code integrationl; (vii) synthesis control for each HDL module; (viii) automated conflict checking between user-generated extensions and existing extensions; (ix) automated generation of HDL from the created extensions and HDL syntax checking; and (x) inclusion of the generated extensions within the programmer's model of the customized processor design.

In the context of the foregoing exemplary ARChitect 2 design environment, the following issues are specifically addressed by the present disclosure: (i) IP source templates—how to model the solution within the existing IP model, including modeling at the description language level (i.e., signals and interface from the user description language to the core description language); (ii) IP destination component—how to build an extension description into an IP Component in the library; and (iii) UI—integration of the features and functionality of the invention into the existing user interface (e.g., GUI). Hence, the software tool described herein is advantageously a “drop-in” module to the ARChitect design environment.

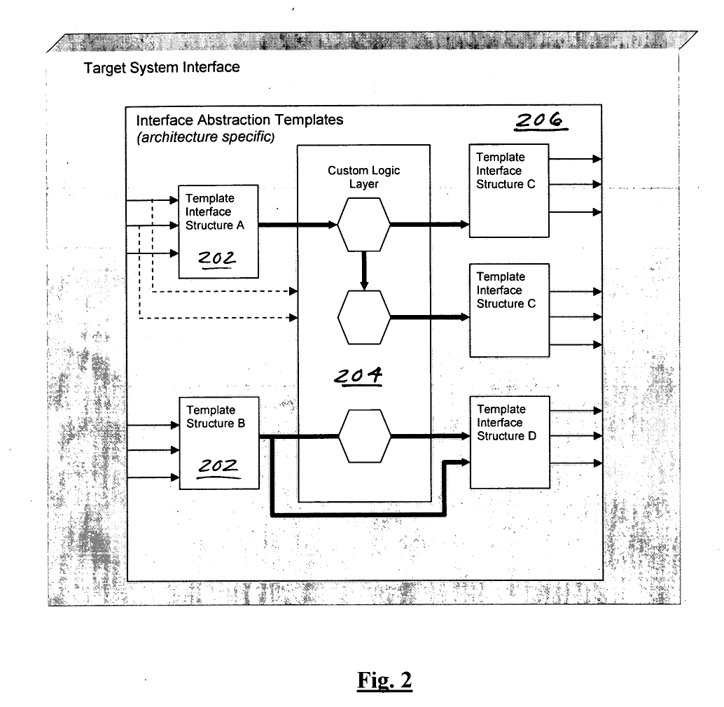

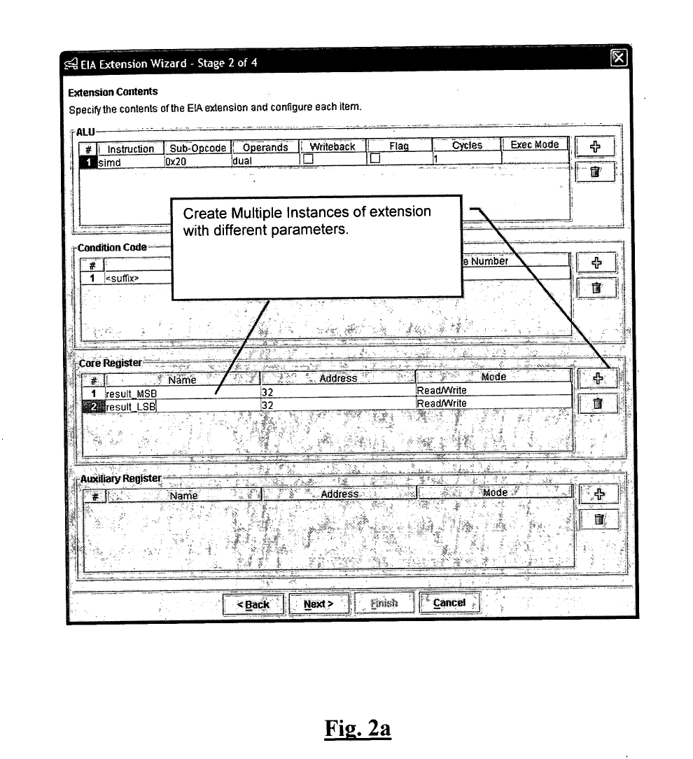

Referring now to FIGS. 2-15, specific aspects of implementing the present invention within the context of the exemplary embodiments are now described in detail.

Model Interface Abstraction

FIG. 2 is a graphical depiction of the method used to abstract the model interfaces according to the invention. It will be appreciated that while the following discussion is cast in terms of three (3) levels of abstraction, more or less levels having varying features and information may be implemented consistent with the invention.

The template interface structures 202 of FIG. 2 contain logic designed to simplify or abstract the interface that is presented to the extension designer. The abstracted interface is then exposed to the custom logic layer 204, where a user extension can be created. The template interface structures 202 contain logic for specific types of extension, such as multi-cycle instructions or core registers for extending processor cores. The template interface structures are also designed so that they can be readily duplicated. Mechanisms are provided in the illustrated implementation that allow minor differences between each instantiation of the extension, such as its physical address. Specifically, the template interface structures contain parameterized values, the definition of which is stored in XML. The tool creates a GUI from the definition (see FIG. 2a), which automatically allows multiple instances of the extension. The user then has control over the parameters for each instance. The custom parameters for each instance are stored within the library component from each extension; when the extension is used in a design, the design environment software checks certain pre-defined parameters to make sure they are valid and do not clash. The parameters checked by the design environment in the exemplary embodiment include memory maps, auxiliary register maps, and opcode maps. If there is a clash, the user can return to the GUI definition and change the parameter to remove the clash. Opcode/Register values are, in the illustrated embodiment, initially created as a default derived from the XML; the user may then modify them if they wish.

The custom logic is supported on any target architecture by providing different interface abstraction templates 206.

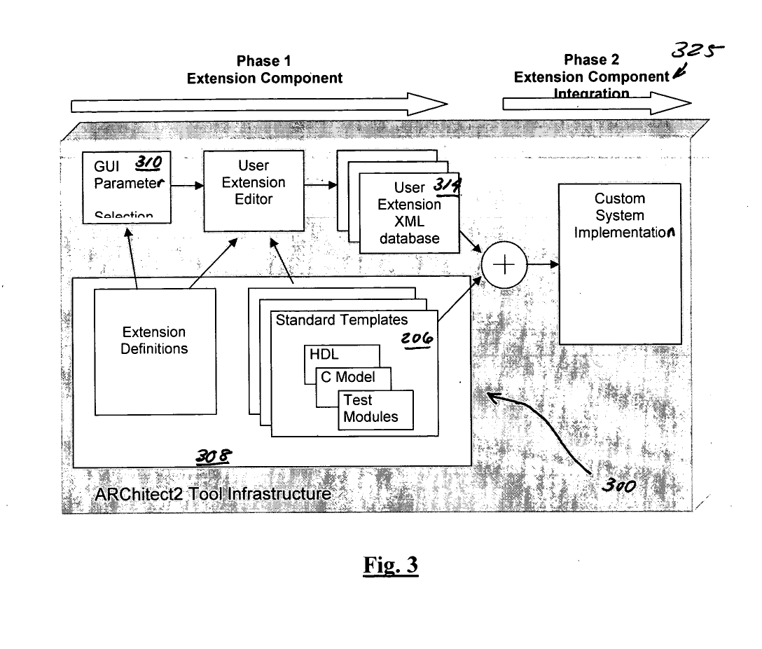

The model interface abstraction architecture of FIG. 2 is, in the exemplary embodiment, rendered within the previously described object-oriented design environment in the form of a software tool or module. FIG. 3 illustrates one exemplary configuration of this tool 300. The interface abstraction templates 206 of FIG. 2 are stored in a markup language (e.g., XML) database 308, along with data specific to each interface structure. This extra data defines the behavior of the interface, and allows configurable parameters to be defined by the user. A second software tool (not shown) is optionally used to interpret the template data and create a graphical user interface (GUI); this GUI allows a user to specify the template parameters 310 so that a custom interface can be created. FIG. 4 shows one embodiment of a GUI generated by data stored within extension templates of the database 308.

As previously referenced, one advantage of the technique of abstracting the custom interfaces into separate templates as described herein is that if the target architecture changes, only the abstracted extension templates need to be modified to take the change into account; the extension components available in the (XML) database need not be modified. Also, the XML definitions of the abstracted components references the templates in their native language; therefore new extension component templates and source files can be added without the need for modifying the tools that reference them. This makes it easy to add new extension components and to extend the functionality of existing extension components.

Yet a further advantage of this technique is that the target architecture does not need to exist when the custom extension is created. When new target architectures are developed, the abstracted templates can be implemented for the new target architecture, so that all existing extension components will be compatible with the new architecture. This provides great flexibility and significantly reduces the time and effort needed to implement a new target architecture, since existing extensions can be immediately adapted for use therewith.

In the illustrated embodiment, four different extension component types are configurable (see FIG. 4): ALU extensions 414a, Condition Code extensions 414b, Core Register extensions 414c, and Auxiliary Register extensions 414d. It will be appreciated that other extension component types may be configured including, without limitation, third party IP extensions, those illustrated being merely exemplary. The customizable parameters 416 shown in FIG. 4 are generated directly from the XML definitions, although other methods of defining these parameters may be used.

The architecture of the present embodiment advantageously allows the available templates to be incorporated or aggregated together at the same time to create a single custom extension component, as seen in FIG. 4. Therefore, the interfaces for each template can be integrated together as well. For example, the output of one extension component type can be used as an input to another, as seen in FIG. 2.

In one aspect of the invention, the aforementioned software tool allows custom logic to be entered by providing a context sensitive editor to the user. FIG. 5 shows an exemplary GUI of one embodiment of the context sensitive editor 502. The editor 502 shows the custom logic 504, exposes the simplified interface, and allows access to all available target system interface signals for more complex extensions (shown by the dashed lines 240 in FIG. 2). A “tooltip” graphical element 510 of the type well known in the GUI arts is also optionally provided, the tootip providing the interface definitions accessed from (XML) database 308. It will be appreciated that since the definition of the extension component is available in a substantially universal (here, XML) database, any tools can access the parameters associated with each component.

The custom logic entered via the editor 502 is then stored in a User Extension XML Database 314 (FIG. 3). Once an extension component is available in the User Extension XML Database 314, the component can be automatically integrated into a system design. Because the extension component definitions reside in the XML database 308, literally any tool may access the parameters associated with each extension component. For example, the tooltip 510 in FIG. 5 previously described is generated using data from the XML database in this fashion.

The parameters in the XML database 308 remain customizable, even after the custom extension component has been implemented. In one embodiment, the system creates a GUI that allows these customizable parameters to be modified when the component is used in a design.

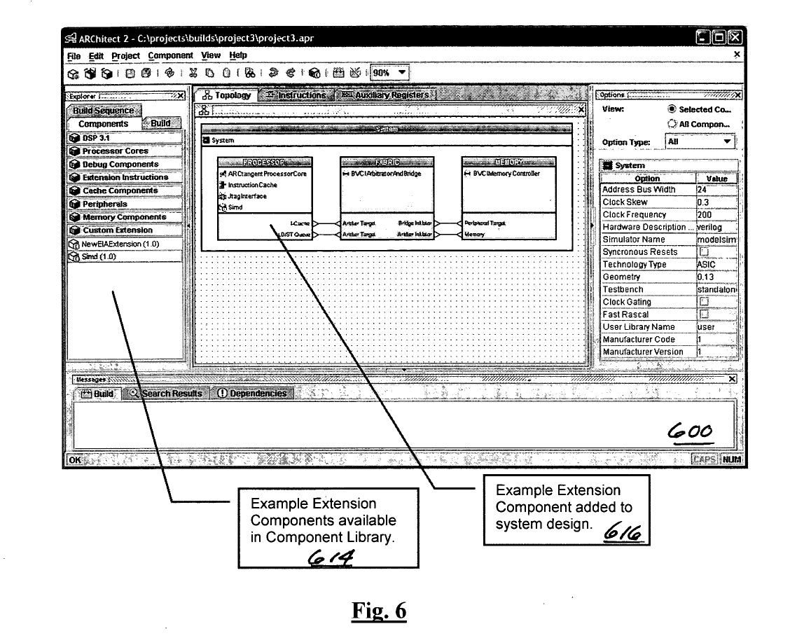

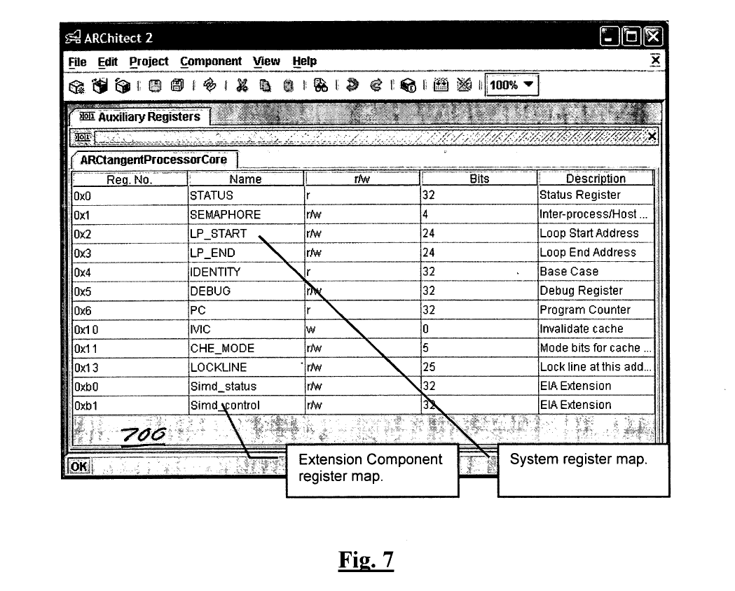

In the illustrated embodiment, the User Extension XML Database 314 also contains the appropriate source code for the extension, as well as additional data that defines how the component will integrate with another design. The software tool of the invention can combine these extension component data with the system data when the component is added to a design, thereby allowing the tool to (i) generate custom documentation for the design, and (ii) create GUI displays representing the entire system design (or selected portions thereof). FIG. 6 is a graphical representation of one embodiment of a display 600 used to provide this functionality. The extension component 616 is added to a circuit design, and any components 614 available in the User Extension XML Database 314 may be added to the design as well. FIG. 7 is a graphical representation of one embodiment of a display GUI 700 combining the extension component data into the system displays. The aforementioned software tool uses the data in the User Extension XML database 314 (FIG. 3) to integrate the extension component 616 with the standard extension templates 306, which is then integrated into the system design. The second phase 325 shown in FIG. 3 illustrates this process.

The extension component parameters, such as register and memory maps, are also made available to perform DRC/dependency checks when the component is added to the system. For example, in one embodiment of this invention, the data is used to check for memory and register map conflicts with existing components in the system design. These checks are performed according to well known algorithms, and accordingly not described further herein.

Appendix A hereto provides exemplary code used in implementing this functionality.

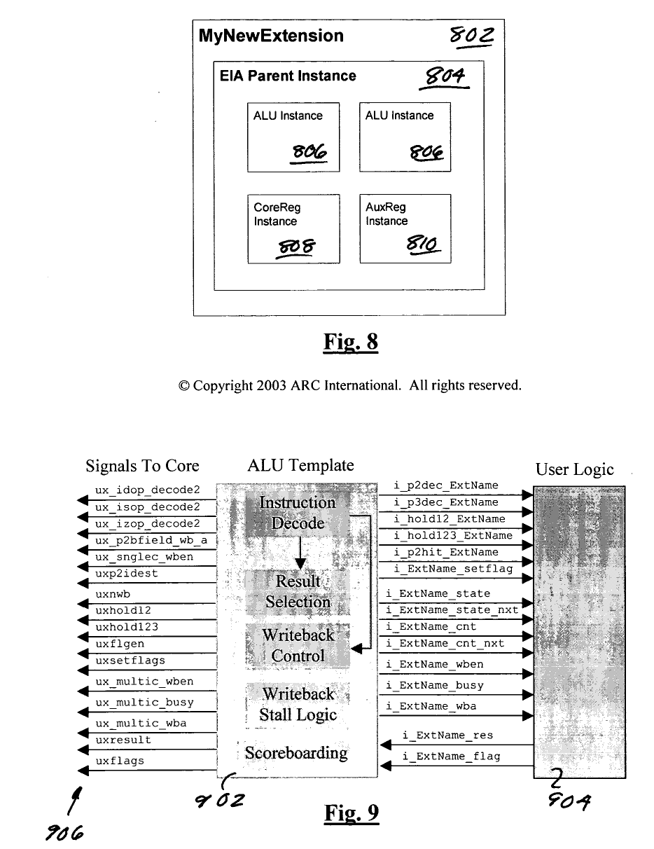

Referring now to FIG. 8, one exemplary configuration of an extension component according to the invention is described. This component would be disposed, for example, within the IP library of the previously described design environment. The extension component 802 contains an extension parent 804, which may have as children one or more extension ALU instances 806, condition code units (not shown), core register instances 808, and auxiliary register instances 810. To provide the desired functionality previously described, the exemplary extension component 802 of FIG. 8 comprises (i) extension templates, (ii) extension test templates, (iii) user provided ALU extension logic (e.g., %%ExtensionName%%.v(hdl)), (iv) user provided extension test code (e.g., %%ExtensionName%%.s), (v) user provided parameters through a GUI or other user interface (e.g., uxdefs.v(hdl)), and (vi) integration files. These entities and their interrelationships are now described in detail.

Extension Component Templates

The extension component templates comprise 1) extension templates and 2) extension test templates.

Extension templates—Extension templates generate the control logic for extension ALUs 806 and condition codes, and the complete implementation of extension registers. These templates also provide a bridge to connect the extensions to the processor core. Extension templates comprise, inter alia, a) an ALU extension template (e.g., xalu.v(hdl)), b) condition code extension template (xcondcode.v(hdl)), c) core register extension template (xcorereg.v(hdl)), d) auxiliary register extension template (xauxreg.v(hdl)), e) extension placeholder template (extension.v(hdl)), f) extension constants placeholder template (uxdefs.v(hdl)), g) extension wrapper template (extension-wrapper.v(hdl)), and h) extension wrapper placeholder template (userextensions.v(hdl)). The ALU, condition codes, and registers templates can be used multiple times within a single extension to form an extension component with multiple extension instructions, condition codes, and registers, thereby providing significant design flexibility.

ALU template—xalu.v(hdl)—The exemplary ALU template contains the implementation of necessary control logic to provide extension execution result (ALU result and extension or updated flags) to the processor at the end of execution stage of the pipeline. This template is used to generate control logic for the following three basic types of extension instructions: (1) dual operand; (2) single operand; and (3) zero operand. For each of these three types of extension instructions, the following options are provided: (a) instruction name; (b) instruction opcode; (c) number of cycles; (d) multi-cycle execution mode: pipelined or stalled result write-back; (e) allowing flag setting (or the use of “.F”) with the extension in assembler code; (f) result write back (not applying for zero operand instructions); and (g) result write back with stall (multi-cycle dual or single operand instructions only).

The control logic generated in the exemplary ALU template includes instruction decode logic, result selection logic, result write back control logic, writeback stall logic, and register scoreboarding logic.

FIG. 9 illustrates an exemplary interface between this ALU template 902 and the ALU extension logic 904 provided by users, as well as the signal set 906 provided to the processor core. The string “ExtName” occurring in all ALU template/user logic signal names in FIG. 9 represents a replacement variable “%%instruction_name%%”, which is replaced at extension component/core build time by the real extension name assigned by the user. The signals 910 appearing in the interface between ALU template 902 and user logic 904 are generated internally and used by the template itself. They are made conditionally available to, or required from, the user depending on the type of extension and options selected. The availability and description of these signals are described in Table 2 below.

TABLE 2

| Signal Name | Direction | Conditions | Description |
|---|---|---|---|
| i_p2dec_ExtName | To user | Always on | Stage 2 instruction decode signal |
| i_p3dec_ExtName | To user | Always on | Stage 3 instruction decode signal |
| i_hold12_ExtName | To user | Pipelined multi-cycle, | Pipeline stage 2 stall signal generated by |
| | | writeback | scoreboarding logic |
| i_hold123_ExtName | To user | Stalled multi-cycle, | Pipeline stage 3 stall signal for result |
| | | writeback | writeback |
| i_p2hit_ExtName* | To user | Pipelined multi-cycle, | Indicate whether a stage 2 instruction |
| | | writeback | accesses the destination register of this |
| | | | extension |
| i_ExtName_setflag | To user | Multi-cycle, Pipelined, | Indicates whether to set flag by this |
| | | Set flag allowed | multi-cycle extensions |
| i_ExtName_state* | To user | Multi-cycle | Multi-cycle extension execution state: |
| | | | busy or finished |
| i_ExtName_state_nxt* | To user | Multi-cycle | Multi-cycle extension execution state: |
| | | | still busy or to be finished at next cycle |
| i_ExtName_cnt* | To user | Multi-cycle | Registered cycle count |
| i_ExtName_cnt_nxt* | To user | Multi-cycle | Cycle count to be registered |
| i_ExtName_wben | To user | Multi-cycle Pipelined | Multi-cycle extension writeback enable |
| i_ExtName_busy | To user | Multi-cycle | Multi-cycle extension busy |
| i_ExtName_wba | To user | Multi-cycle writeback | Multi-cycle extension writeback address |
| | | | latched from stage 2 |
| i_ExtName_res | From user | Writeback | Extension ALU result |
| i_ExtName_flag | From user | Set flag allowed | Extension flag result |

*Internally used signals and not to be used by the extension wrapper or the processor

As can be seen in FIG. 9 and Table 2, all signals in the interface will be present conditionally except for the instruction decoding signals. The ALU template 902 declares two signals, i_ExtName_res and i_ExtName_flag, and requires the user logic 904 to provide extension ALU result and/or flag result on these two signals. All other signals are declared conditionally within the template and made available to the user if they are present. The user logic 904 should avoid declaring any signals appearing in this interface.

Instruction decode logic generates the extension instruction decode for use in the ALU template 902, extension wrapper template (e.g., extension_wrapper.v(hdl)), and the processor core. It generates both stage 2 and stage 3 decode signals, i.e., i_p2dec_ExtName and i_p3dec_ExtName. Three sets of these signals are generated for dual, single, or zero operand instructions, respectively. Each of these signals has multiple implementations, and a set of replacement variables are used to select the implementation of a specific signal. All implementations that are not selected are not merged into the placeholder at extension

TABLE 3

| | | Extension Type and |
|---|---|---|
| Replacement Variable | Selected Signal | Options |
| remove_if_not_dop32 | i_p2dec_%%instruction_name%% | Dual operand |
| remove_if_not_p3dec_dop32_with_en3 | i_p3dec_%%instruction_name%% | Dual operand but not a |
| | | multi-cycle instruction with stall |
| remove_if_not_p3dec_dop32_without_en3 | i_p3dec_%%instruction_name%% | Dual operand multi-cycle |
| | | instruction with stall |
| remove_if_not_sop32 | i_p2dec_%%instruction_name%% | Single operand |
| remove_if_not_p3dec_sop32_with_en3 | i_p3dec_%%instruction_name%% | Single operand but not a |
| | | multi-cycle instruction with stall |
| remove_if_not_p3dec_sop32_without_en3 | i_p3dec_%%instruction_name%% | Single operand multi- |
| | | cycle instruction with stall |
| remove_if_not_zop32 | i_p2dec_%%instruction_name%% | Zero operand |
| | i_p3dec_%%instruction_name%% | |

The illustrated embodiment provides a special stage 3 decode signal for multi-cycle instructions with stall, since the decode of this type of instruction cannot be qualified with the stage 3 enable signal (en3), otherwise it will hold the pipeline indefinitely.

The extension instruction decoding logic also provides stage 2 instruction decode information for the core, as described in Table 4.

TABLE 4

| | Logic turned on | Extension Type |
|---|---|---|
| Replacement Variable | for output signal | and Options |
| remove_if_not_dop | ux_idop_decode2 | Dual operand |
| remove_if_not_sop | ux_isop_decode2 | Single operand |
| remove_if_not_zop | ux_izop_decode2 | Zero operand |

In Table 4, a replacement variable turns on the logic that drives the desired output signal if the extension matches the type and option described in the last column.

The result selection logic of the illustrated embodiment adds the user-provided extension results (ALU and/or flags) onto a multiplexer (MUX) created in the extension placeholder template (extension.v(hdl)). Again, it generates two possible entries to the MUX, and four replacement variables are used to select the logic producing desired results. This is shown in Table 5 below.

TABLE 5

| | Logic turned | |
|---|---|---|
| | on for output | Extension Type |
| Replacement Variable | signal | and Options |
| remove_if_not_scwb | Uxresult | Single cycle, |
| | | writeback |
| remove_if_not_mc_wb | Uxresult | Multi-cycle, |
| | | writeback |
| remove_if_no_sc_flag | Uxflags | Single cycle, |
| | | allow flag setting |
| remove_if_not_mcpipe_setflag | Uxflags | Multi-cycle, pipelined, |
| | | allow flag setting |

In Table 5, a replacement variable turns on the logic that drives the desired output signal if the extension matches the type and option described in the last column.

The exemplary result writeback process consists of (i) ALU result writeback, and (ii) flag update. For single cycle extension instructions, signal ux_snglec_wben is set when the instruction enters into stage 3 of the pipeline. However, for multi-cycle extension instructions, the ALU result writeback control is more complicated, and the writeback is controlled by a set of three signals, i.e., (1) ux_multic_wben indicating when the result is ready, (2) ux_multic_wba providing the writeback address, and (3) ux_multic_busy indicating whether the extension instruction has finished.

For all single operand instructions that will write the ALU result back to a register, the control signal ux_p2bfield_wb_a should be set when the instruction enters into stage 2. If the extension instruction will not perform a writeback, then signal uxp2idest and uxnwb should be set when the extension enters into stage 2 or stage 3, respectively. In the illustrated embodiment, tese signals have all been implemented in the ALU template 902, and the desired implementation logic is selected by replacement variables as shown in Table 6.

TABLE 6

| | Logic turned | |
|---|---|---|
| | on for output | Extension Type |
| Replacement Variable | signal | and Options |
| remove_if_not_scwb | ux_snglec_wben | Single cycle, |
| | | write-back |
| remove_if_not_mc_wb | ux_multic_wben | Multi-cycle, |
| | | write-back |
| remove_if_not_mc_wb | ux_multic_wba | Multi-cycle, |
| | | write-back |
| remove_if_not_mc_wb | ux_multic_busy | Multi-cycle, |
| | | write-back |
| remove_if_not_sop32_wb | ux_p2bfield_wb_a | Single operand, |
| | | write-back |
| remove_if_not_scnwb_or_mcpipe | uxp2idest, uxnwb | Single cycle, no |
| | | write-back or |
| | | pipelined multi- |
| | | cycle, write-back |

The write-back address for a multi-cycle extension instruction is latched from the stage 2 address bus (e.g., dest), and a state machine is implemented to provide the result write-back enable and instruction busy information. There are three exemplary implementations for this state machine, and replacement variables are used to control the selection of these implementations through the user-selected options as shown in Table 7 below.

TABLE 7

| Replacement Variable | Extension Type and Options |
|---|---|
| remove_if_not_mcpipe_wb | Multi-cycle, pipelined, write-back |
| remove_if_not_mcpipe_nwb | Multi-cycle, pipelined, no write-back |
| remove_if_not_mcstall_wb | Multi-cycle, stalled, write-back |

Extension flag update is controlled by the signal uxsetflags for multi-cycle extensions, and by ux_flgen for single cycle extensions. In order to allow multi-cycle extensions to set flags when its result is written back, the stage 3 signal p3setflags is latched until the multi-cycle write-back enable becomes valid, and uxsetflags is set by this signal at write-back, which then forces the core to update the flags from extension flags. Table 8 describes the flag update control of the illustrated embodiment.

TABLE 8

| | Logic turned | |
|---|---|---|
| | on for output | Extension Type |
| Replacement Variable | signal | and Options |
| remove_if_no_sc_flag | ux_flgen | Single-cycle, |
| | | allow flag update |
| remove_if_not_mcpipe_setflag | ux_flgen | Multi-cycle, |
| | | pipelined, allow |
| | | flag update |
| remove_if_not_mcpipe_setflag | uxsetflags | Multi-cycle, |
| | | pipelined, allow |
| | | flag update |

Regarding the pipeline stall logic, the ALU template 902 generates pipeline stage 2 stall logic for register scoreboarding, and stage 3 stall logic for multi-cycle extensions writing back result by stalling the pipeline. The stage 2 scoreboarding logic sets the stage 2 stall signal uxholdup12 when the instruction in stage 2 accesses the destination register of an unfinished multi-cycle extension instruction. The stage 3 stall logic sets uxholdup123 when a multi-cycle extension instruction with stalled write-back reaches pipeline stage 3. Table 9 illustrates this functionality.

TABLE 9

| | | Extension Type |
|---|---|---|
| Replacement Variable | Stall logic for | and Options |
| remove_if_not_mcpipe_wb | Stage2 | Multi-cycle, |
| | (uxholdup12) | pipelined, |
| | | write-back |
| remove_if_not_mcstall_wb | Stage3 | Multi-cycle, |
| | (uxholdup123) | stalled write-back |

Condition code template—xcondcode.v(hdl)—An exemplary hardware interface between the condition code (cc) template and users is shown in FIG. 10. The cc template 1002 uses user supplied condition code suffix and values 1004 to perform the condition code decode, and passes the user-provided condition true signal i_%%suffix%%_cc to the core through uxp2ccmatch (stage 2) and uxp3ccmatch (stage 3). The condition true signal i_%%suffix%%_cc is declared within the template 1002 and should be assigned within the user logic 1004. In the exemplary embodiment, this signal comprises a ‘1’ or 1'b1 if the desired condition is met.

Core register template—xcorereg.v(hdl)—This template supports three types of core register extension: (1) read only; (2) write only; and (3) read/write. In the present embodiment, the read only type of core registers are not made available for users. This type of registers are used for storing ALU results without using the normal write-back path. To support this type of core registers, one-to-one mappings between ALU results and core registers need to be implemented in UI wizard when an extension contains multiple ALUs and multiple core registers. The core register template always implements write-through logic and puts any extension registers onto shortcut path. This template further implements automatically the register scoreboarding if a core register is used by a multi-cycle instruction. The options provided by this template include: (i) register name; (ii) register address; (iii) working mode: write-only or read/write.

An exemplary user interface of the core register extension template is shown in FIG. 11. As shown therein, no user logic is needed to extend a core register. The description of the interface signals declared within the template to the user is given in Table 10 below. However, it will be noted that some signals are conditionally available to users based on the options selected.

TABLE 10

| | Direc- | | |
|---|---|---|---|
| Signal Name | tion | Conditions | Description |
| i_%%xcore_name%%_cr | To user | Always on | Extension core |
| | | | register value. |
| i_%%xcore_name%%_cr_nxt | To user | Always on | Extension core |
| | | | register value |
| | | | at next cycle. |
| i_%%xcore_name%%_cr_busy | To user | scoreboarding | Indicate whether |
| | | | the register is |
| | | | busy. |
| i_p2_%%xcore_name%%_hit | To user | scoreboarding | Indicate whether |
| | | | the register is |
| | | | accessed by the |
| | | | instruction at |
| | | | stage 2. |

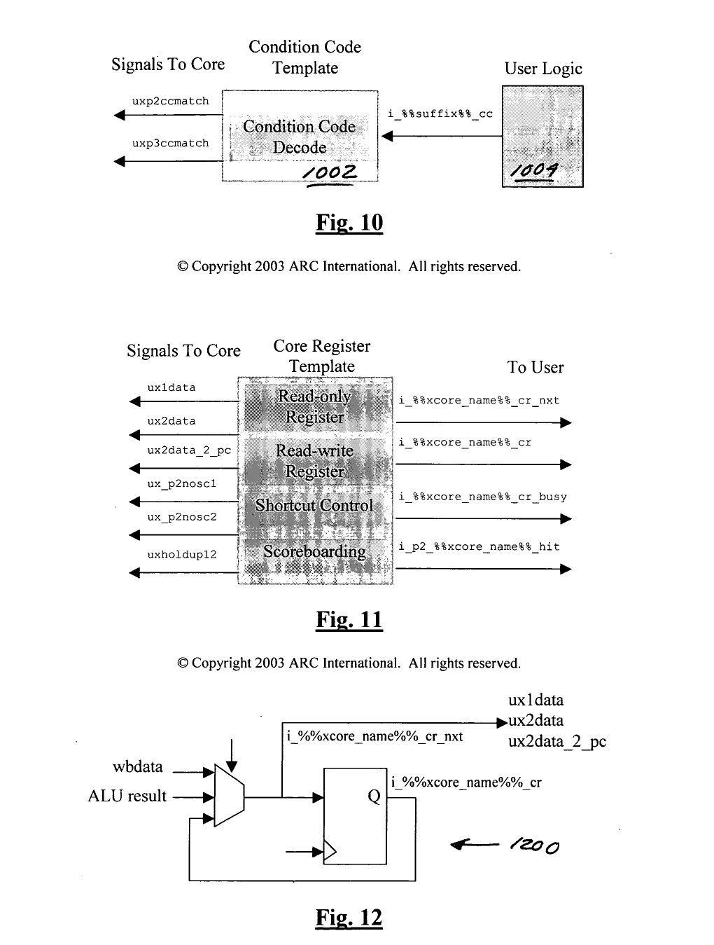

The replacement variables used to generate core registers are described in Table 11. Exemplary gate logic 1200 of the core register template (with write-through) is shown in FIG. 12, although it will be recognized that other logic structures and methods may be used to provide the desired described functionality.

TABLE 11

| | | Extension Type |
|---|---|---|
| Replacement Variable | Logic selected | and Options |
| remove_if_not_xcore_ro | Read-only register | Read-only |
| remove_if_not_xcore_rw | Read-write register | Read-write |
| remove_if_no_xcore_sb | Scoreboarding | Scoreboarding |
| remove_if_not_xcore_rw_store_res | Direct write | Direct write |

Auxiliary register template—xauxreg.v(hdl)—The exemplary embodiment of the auxiliary register template according to the invention supports only write-only or read/write single-access auxiliary register extension. The template is configured to provide scoreboarding if it is used along with a multi-cycle instruction; this prevents accessing the extension auxiliary register when the multi-cycle instruction has not finished. The following options are available from this template: (i) register name; (ii) register address; and (iii)working mode: write-only or read/write.

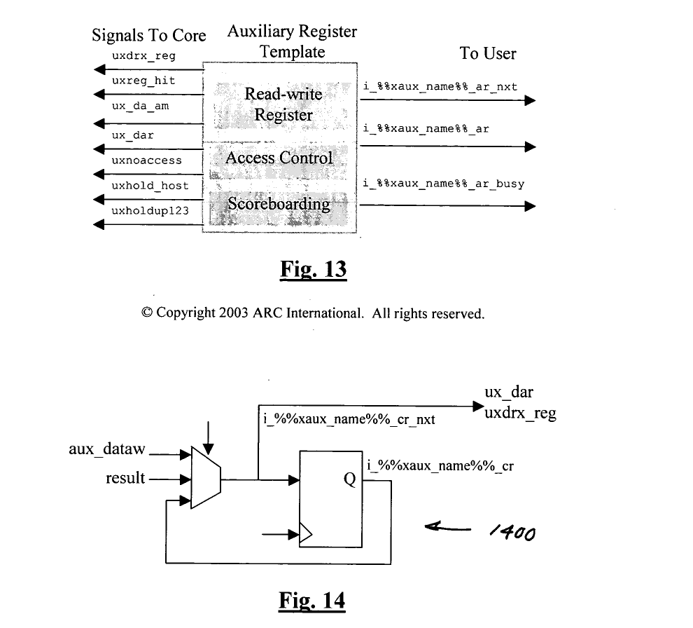

An exemplary interface of auxiliary register extension template is shown in FIG. 13. As shown in FIG. 13, no user logic is needed to extend an auxiliary register. The description of the interface signals declared within the template is given in Table 12. However, some signals are conditionally available to users based on the options selected.

TABLE 12

| Signal Name | Direction | Conditions | Description |
|---|---|---|---|
| i_%%xaux_name%%_ar | To user | Always on | Extension auxiliary register value. |
| i_%%xaux_name%%_ar_nxt | To user | Always on | Extension auxiliary register value at |
| | | | next cycle. |
| i_%%xaux_name%%_ar_busy | To user | Used by multi-cycle | Indicate whether the register is busy. |
| | | instructions | |

The replacement variables used to generate auxiliary registers are described in Table 13, and exemplary template logic 1400 is shown in FIG. 14.

TABLE 13

| | | Extension Type |
|---|---|---|
| Replacement Variable | Logic selected | and Options |
| remove_if_not_xauxreg_sb | Scoreboarding | Scoreboarding |
| remove_if_not_xcore_rw_store_res | Direct write | Direct write |

It will be appreciated that while the auxiliary register extension described in the exemplary embodiment supports 32-bits, the present invention may be adapted for extensions of literally any length, including without limitation 16-bits and 64-bits.

Extension placeholder template—extension.v(hdl)—In the illustrated embodiment, the extension placeholder template is copied to the directory pointed to by the user library (e.g., build_dir\vhdl) at build time, and renamed to the extension name. Within this template, a minimal extension interface to the core is defined according to the types and selected options of the instructions, condition codes, and registers within this extension. The interface consists of the interfaces for the ALU extension, condition code extension, auxiliary register extension, and core register extension respectively. Every signal appearing in the interface is selected by a replacement variable, and some signals in the interface are shared by different types of extensions. Tables 14-17 describe these interfaces for the ALU extension, condition code extension, auxiliary register extension, and core register extension, respectively.

TABLE 14

| | Signals | Direc- | |
|---|---|---|---|
| Replacement Variable | turned on | tion | Conditions |
| remove_if_no_reg_or_mc | ck*, | in | Contains an extension register or |
| | clr* | | multi-cycle instruction |
| remove_if_no_alu | en2, | in | Contains an extension instruction |
| | en3, | | |
| | aluflags_r | | |
| remove_if_no_dop | s1val | in | Contains a dual operand extension |
| | | | instruction |
| remove_if_no_dop_sop | s2val | in | Contains a dual or single operand |
| | | | extension instruction |
| remove_if_no_dop32 | p2dop32_inst, | in | Contains a 32-bit dual operand |
| | p2subopcode, | | extension instruction |
| | p3dop32_inst, | | |
| | p3subopcode, | | |
| remove_if_no_sop32 | p2sop32_inst, | in | Contains a 32-bit single operand |
| | p2a_field_r, | | extension instruction |
| | p3sop32_inst, | | |
| | p3a_field_r | | |
| remove_if_no_zop32 | p2zop32_inst, | in | Contains a 32-bit zero operand |
| | p2b_field_r, | | extension instruction |
| | p3zop32_inst, | | |
| | p3b_field_r | | |
| remove_if_no_p2dest | dest*, | in | Contains a multi-cycle instruction |
| | desten* | | and |
| | | | 1. with result write-back or |
| | | | 2. contains a core register |
| remove_if_no_mcpipe_setflag | p3setflags | in | Contains a multi-cycle pipelined |
| | | | instruction and allows flag setting |
| | | | (.F) |
| remove_if_no_mcwb | p3_xmultic_nwb | in | Contains a multi-cycle instruction |
| | | | with result write-back |
| remove_if_no_dop | ux_idop_decode2 | out | Contains a dual operand extension |
| | | | instruction |
| remove_if_no_sop | ux_isop_decode2 | out | Contains a single operand |
| | | | extension instruction |
| remove_if_no_zop | ux_izop_decode2 | out | Contains a zero operand extension |
| | | | instruction |
| remove_if_no_flag | ux_flgen, uxflags | out | Allows flag setting (.F) |
| remove_if_no_mcpipe_setflag | uxsetflags | out | Contains a multi-cycle pipelined |
| | | | instruction and allows flag setting |
| | | | (.F) |
| remove_if_no_scwb | ux_snglec_wben | out | Contains a single cycle instruction |
| | | | with result write-back |
| remove_if_no_sop32_wb | ux_p2bfield_wb_a | out | Contains a 32-bit single operand |
| | | | extension instruction with write- |
| | | | back |
| remove_if_no_scnwb_or_mcpipe | uxnwb, uxp2idest | out | Contains a single cycle instruction |
| | | | without result write-back or a |
| | | | multi-cycle pipelined instruction |
| remove_if_no_mc | ux_multic_busy | out | Contains a multi-cycle instruction |
| remove_if_no_mcwb | ux_multic_wben, | out | Contains a multi-cycle instruction |
| | ux_multic_wba | | with result write-back |
| remove_if_no_wb | uxresult | out | Contains an extension instruction |
| | | | without result write-back |

*shared signals with other types of extensions

TABLE 15

| | Signals | Direc- | |
|---|---|---|---|
| Replacement Variable | turned on | tion | Conditions |
| remove_if_no_cc | p2cc, | In | Contains an |
| | p3cc | | extension |
| | | | condition code |
| remove_if_no_cc | uxp2ccmatch, | Out | Contains an |
| | uxp3ccmatch | | extension |
| | | | condition code |

TABLE 16

| | Signals | Direc- | |
|---|---|---|---|
| Replacement Variable | turned on | tion | Conditions |
| remove_if_no_p2s1a | s1a* | in | Contains a multi-cycle pipelined instruction |
| | | | with result write-back or an extension core |
| | | | register |
| remove_if_no_xcorereg | s2a | in | Contains an extension core register |
| remove_if_no_p2fs2a | fs2a* | in | Contains a multi-cycle pipelined instruction |
| | | | with result write-back or an extension core |
| | | | register |
| remove_if_no_p2s1en | s1en* | in | Contains a multi-cycle instruction that |
| | | | 1. is pipelined with result write-back |
| | | | or |
| | | | 2. contains a core register |
| remove_if_no_p2s2en | s2en* | in | Contains a multi-cycle instruction that |
| | | | 1. is pipelined with result write-back |
| | | | or |
| | | | 2. contains a core register |
| remove_if_no_xcore_wr | wba, | in | Contains a write-only or read-write core |
| | wben, | | register |
| | wbdata | | |
| remove_if_no_xcorereg | Ux1data, | out | Contains a core register |
| | ux2data, | | |
| | ux2data_2_pc, | | |
| | ux_p2nosc1, | | |
| | ux_p2nosc2 | | |

*shared signals with other types of extensions

TABLE 17

| | Signals | Direc- | |
|---|---|---|---|
| Replacement Variable | turned on | tion | Conditions |
| remove_if_no_xauxreg | aux_addr | in | Contains an extension |
| | | | auxiliary register |
| remove_if_no_xauxreg_wr | aux_dataw, | in | Contains a write-only or read-write |
| | aux_write | | extension auxiliary register |
| remove_if_no_xauxreg_host | h_addr, | in | Contains an extension auxiliary |
| | aux_access | | register with dual access or |
| | | | no host access |
| remove_if_no_xauxreg_sb | p3lr, | in | Contains an extension auxiliary |
| | p3sr | | register and a multi-cycle instruction |
| remove_if_no_xauxreg_rd | uxdrx_reg, | out | Contains a read-only or read-write |
| | uxreg_hit | | extension auxiliary register |
| remove_if_no_xauxreg_da | ux_da_am, | out | Contains a dual accessible |
| | ux_dar | | extension auxiliary register |
| remove_if_no_xauxreg_nha | Uxnoaccess | out | Contains an extension auxiliary |
| | | | register with host access disabled |
| remove_if_no_xauxreg_dahh | uxhold_host | out | Contains a dual accessible |
| | | | extension auxiliary register that |
| | | | stalls the host when necessary |

The extension placeholder template illustrated herein can be used for an extension instruction, an extension condition code, an extension core or auxiliary register, or any combination of these types of extension. The template is also advantageously configured to accommodate multiple instructions, condition codes, and registers (aux or core) within a single extension. All instructions, condition codes, registers contained within an extension are merged into this template at build time.

Extension constants placeholder template—uxdefs.v(hdl)—This template is provided to hold any constants of which the software tool is aware to avoid “magic” numbers (i.e., instruction opcodes, register addresses, condition code numbers, and any user-defined constants) in generated HDL or similar output files. In the illustrated embodiment, the constants placeholder template comprises an empty template with replacement variables defined as set forth in Table 18.

TABLE 18

| Replacement | |
|---|---|
| Variable | Description |
| dopcode | Declarations of opcode constants for all |
| | dual operand extension instructions in an |
| | ARChitect2 build |
| sopcode | Declarations of opcode constants for all |
| | single operand extension instructions in |
| | an ARChitect2 build |
| zopcode | Declarations of opcode constants for all |
| | zero operand extension instructions in an |
| | ARChitect2 build |
| condcode | Declarations of condition code constants |
| | for all extension condition codes in an |
| | ARChitect2 build |
| cr_addr | Declarations of address constants for all |
| | extension core registers in an |
| | ARChitect2 build |
| ar_addr | Declarations of address constants for all |
| | extension auxiliary registers in an |
| | ARChitect2 build |
| misc_defs | Declarations of any user defined constants |

Extension wrapper template—extension-wrapper.v(hdl)—The extension wrapper template defines the declaration and instantiation of an extension (either a single instruction or multi-instruction extension) in the extension wrapper placeholder template or userextensions.v(hdl). Any internal signals required to instantiate the extension are generated; however, these internal signals are not available to users as they are disposed in a higher level within the hierarchy. The extension wrapper template also adds any output signals from the extension onto the multiplexers provided by the placeholder template userextensions.v(hdl). The replacement variables used in the wrapper template are identical to those used in the extension placeholder template.

Extension wrapper placeholder—userextensions.v(hdl)—This template is the top level of all user created extensions, and connects these extensions to the core. A multiplexer is generated in this template to route each extension output to the core. If more than one multi-cycle extension instructions are integrated into core within a given build, a result write-back priority arbiter is created for these instructions to resolve the write-back contention (at the same cycle).

The full extension interface using the tool of the present invention is described by the exemplary VHDL port list shown in Appendix B.

Extension test templates—Extension test templates (e.g., placeholder template xtest.s) provide a mechanism for the extensions to be tested through the prevailing test environment (e.g., ARCtest in the illustrated embodiment). These test templates generate extension test code wrapper and compiler directives for the extensions. These templates include the extensions test placeholder; and extension cross-reference template.

Extension test placeholder template—xtest.s—This template provides a wrapper for user test code which is merged into the place defined by the pragma EXTENSION_TEST_CODE in this wrapper, and it embeds the following replacement variables: (a) ExtensionName: the test file name; and (b) compilerDirectives: declare all extensions under test. The template also includes the following files before the actual test code starts: (1) macros.s; (2) code.s; (3) vectors.s; and (4) int_tests.

The extension test placeholder wrapper also provides following labels:
_start (defined by directive global)
xtest_start
%%ExtensionName%%_start
end_prog
ins_err_handle
   The template initializes the designated test register(s) (e.g., r25 in the illustrated embodiment) at label xtest_start, and reports the test result at label end_prog for success, and ins_err_handle for failure. Users may use the branch address of ins_err_handle to terminate the test when an error is detected for the extension under test.

Extension cross-reference template—test.xref—This template is for test (e.g. ARCtest) integration. It adds a cross reference entry as shown below to the cross-reference placeholder file test.xref in the ARChitect2 build directory:
Always=board %%userdir%%tests/extensions/%%extension_name%% %%userdir%%tests/hmsl/host_program_no_step. hmsl
Extension Component Integration

Integration of an extension component as previously described into the target core is done automatically within the exemplary software design environment (e.g., ARChitect2) by use of replacement variables and filelist files that define copying and merging of files into the build directory. To allow the correct integration of an extension created through the software tool, a set of integration files (Table C-1 in Appendix C) are required to be present in the specified directory, where $template_path points to IPLibrary\com\arc\templates\eia, $eiaLink_path points to IPLibrary\com\arc\links\eia, and $hdl_child refers to, e.g., vhdl_child or verilog_child depending on the description language set for the core build. The extension integration files of the illustrated embodiment comprise: (i) file list files; (ii) variable files; (iii) hierarchy files; (iv) extension integration template (e.g., Lib.list); (v) a test integration template (e.g., test.xref for ARCtest); and (vi) ARChitect2 support data (e.g., register map, condition codes, etc.).

Extension Component Test and Test Program Integration

Compiler directives for any instructions, condition codes, auxiliary registers, and core registers within a single extension are generated by the replacement variable compilerDirectives in the files listed in Table 19 (where $template_path points to a directory; e.g., IPLibrary\com\arc\templates\eia.):

TABLE 19

| Directive File | Description |
|---|---|
| $template_path\ALU\1_0\tests_child\variables | Provides compiler directive |
| | for an extension instruction |
| $template_path\ConditionCode\1_0\tests_child\variables | Provides compiler directive |
| | for an extension condition code |
| $template_path\AnxiliaryRegister\1_0\tests_child\variables | Provides compiler directive |
| | for an extension auxiliary register |
| $template_path\CoreRegister\1_0\tests_child\variables | Provides compiler directive |
| | for an extension core register |

To integrate the test code associated with the extensions of the present invention into a test (e.g. ARCtest) environment, the exemplary files of Table 20 are utilized:

TABLE 20

| Test File | Description |
|---|---|
| $template_path\ALU\1_0\tests_child\variables | Provides compiler directive, makefile entry, and |
| | makefile target for any extension instructions |
| $template_path\ConditionCode\1_0\tests_child\variables | Provides compiler directive for any extension |
| | condition codes |
| $template_path\AuxiliaryRegister\1_0\tests_child\variables | Provides compiler directive for any extension |
| | auxiliary registers |
| $template_path\CoreRegister\1_0\tests_child\variables | Provides compiler directive for any extension |
| | core registers |
| $template_path\Parent\1_0\tests child\xtest.s | The test code to be compiled for the extension test |
| $template_path\Parent\1_0\tests_child\xtest.map | A standard map file |
| $template_path\Parent\1_0\tests_child\test.xref | Adds a new entry for the extension in test.xref |
| | placeholder file |
| $template_path\Parent\1_0\tests_child\fileList | defines the following actions: |
| | copy xtest.s |
| | copy xtest.map |
| | merge test.xref |
| | where $template_path points to |
| | IPLibrary\com\arc\templates\eia. |

The extension tool of the present invention is also advantageously adapted to permit various other types of testing. For example, in one exemplary variant, the random instruction generator (RIG) test apparatus described in co-owned and co-pending U.S. patent application Ser. No. 10/289,510 filed Nov. 5, 2002 and entitled “Random Instruction Generator Apparatus and Method”, incorporated herein by reference in its entirety, is utilized in conjunction with the extension tool (and design environment). The RIG provides a facility for generating random sequences of assembler language instructions. RIG is not architecture-specific and is generally language “agnostic”, in that it can be programmed using a variety of different languages. The exemplary embodiment is programmable using a form of extensible markup language (XML); the RIG advantageously specifies how to generate random sequences and encapsulates architecture-dependent aspects of the generated instructions. The RIG may be thought of generally as a probabilistic string generator with additional features to support the needs of instruction generation. Additionally, while the RIG XML of the exemplary embodiment is not considered a generalized computational (Turing) language, the programmer can generate expressions that the assembler computes, thereby accommodating a wide variety of computational needs.

As is well known to those in the programming arts, XML is a simple language that expresses a single tree. That tree is “executed” by RIG to generate the random sequences. Certain properties of the tree allow repetition of the execution so that multiple random instructions can be generated.

In that it is not architecture-specific, the RIG is advantageously useful with respect to a variety of different hardware environments, including for example the Tangent A5 RISC processor core previously referenced. This flexibility is well suited to the highly flexible (and architecture “agnostic”) extension tool of the present invention.

It will be appreciated, however, that other types and configurations of test tools may be utilized consistent with the present invention as well.

Verification of Extensions

Extension methodology verification tables are defined within the exemplary configuration of the present invention to test the extensions created through the software tool. All extensions are assumed to contain at least one extension instruction. For extensions containing more than one extension instruction, minimal requirements for extension verification are defined. The test of extension registers is excluded from these verification tables. Exemplary tables are shown in Appendix D hereto.

The illustrated embodiment is also configured to perform write-back “collision” testing for the designated extensions. The following cases are identified to test extension write-back collision, although it will be appreciated that others may be used consistent with the invention: (i) an extension single-cycle instruction writes back result at the same cycle as a load return; (ii) an extension multi-cycle instruction writes back result at the same cycle as a load return; (iii) an extension multi-cycle instruction writes back result at the same cycle as an extension multiply-accumulate (XMAC); and (iv) two extension multi-cycle instructions write back results at the same cycle.

Simulator and Related Tool Extensions

The present invention can advantageously be extended to simulators (e.g., instruction set simulators (ISS) and cycle-accurate simulators (CAS)) and other tools by providing a custom dynamic link library (DLL) that is specific to the extension component. Simulation is vital for system-on-chip (SoC) design because it lets users (e.g., programmers) test and profile their code before the first silicon becomes available. Software-based tools such as CAS and ISS simulators are also a lower-cost alternative to hardware-based development systems, in that multiple users can work in parallel without competing for hardware resources.

In the exemplary instance of the ISS, a standard “C” language interface is implemented that provides the required functionality. The ISS extension C code is constructed in much the same way that the HDL is built using the aforementioned ARChitect2 design environment. Specifically, certain declarations and functionality are provided by the ISS for an ALU extension, likewise for a register and condition code. This information is taken from the software tool extension configuration previously described, and is therefore automated in the exemplary embodiment.

From the software extension tool, the following can be generated: (i) full C template (minus the custom logic); (ii) makefile(s) (e.g., SOLARIS, LINUX AND XP); and (iii) test code (to test the ISS implementation; the test code is common between all the exemplary implementations including ISS, CAS, VHDL, and Verilog). The custom logic, required for ALU operations, may be captured in a similar way to the HDL logic capture previously described, and therefore is provided by the user/designer.

In terms of CAS, a similar solution to that of the ISS described above is provided. For example, in one exemplary embodiment, the CAS™ (Cycle Accurate Simulator) simulator produced by the Assignee hereof is adapted to provide an automated solution comparable to that of the ISS previously described. The CAS simulator provides a cycle-accurate testing environment for the user-customizable processor being designed, and advantageously can operate as a target of an associated debugging tool (e.g., MetaWare® SeeCode debugger). With this exemplary debugger tool, developers can use a single GUI to switch among multiple targets, including the ISS and hardware-based development platforms. Because developers can customize the target processor for specific applications, the CAS simulator is also made user-customizable. Application programming interfaces (APIs) of the type well known in the programming arts are provided to allow developers to use functional and cycle-accurate models of their custom instructions and other extensions with the CAS simulator. Programmers can obtain cycle-accurate feedback while writing code for a custom processor architecture being developed under the aforementioned design environment. In the exemplary embodiment, the CAS simulator is provided as a dynamic link library (DLL) for the selected platform (e.g., Microsoft Windows XP®), or as an SO-format library for Sun® Solaris™ or comparable systems. Users can also advantageously set additional options (such as the cache configuration and extension components) at run time without rebuilding the simulator.

The theory of operation is generally the same for VHDL, Verilog, CAS and ISS. The same XML data definition of the extension types is used as for HDL, so the extension selection GUI is the same (see FIG. 4). The difference is that the templates selected from this definition are specific to the target implementation, i.e. CAS or ISS instead of VHDL or Verilog. These templates abstract the ISS and CAS interfaces to the same interface that the VHDL and Verilog use. The same GUI interface is used to create and edit the custom extension as with the VHDL and Verilog, the only difference being the language for the particular target model. An advantage with CAS and the ISS is that they are both defined in C/C++, and because the interface to the underlying model is contained within the templates, the implementation of the extension for CAS and ISS is identical. The CAS implementation may contain extra timing information to maintain the cycle accuracy of the complete processor CAS model; when this is the case the timing information is ignored by ISS implementation.

As an example of the foregoing, for the simplest of dual operand extensions, the different implementations of an ALU operation that would need to be implemented on the four different target models would be:

| | |
|---|---|
| VHDL - | i_simd_res = s1val + (s2val / 2); |
| Verilog - | i_simd_res = s1val + (s2val / 2); |
| CAS - | i_simd_res = s1val + (s2val / 2); |
| ISS - | i_simd_res = s1val + (s2val / 2); |

As with VHDL and Verilog, the CAS and ISS extensions are used to create a library component for the design environment (e.g., ARChitect) tool. The library component contains all the source code and support files (makefiles, testcode etc) for each extension component. When the model is defined for more than one target implementation, all models are stored in the same library component, therefore the library may contain the following elements: (i) VHDL Model; (ii) Verilog Model; (iii) CAS Model; (iv) ISS Model; (v) Model Data (OpCodes etc); (vi) Test Code; and (vii) Makefiles (for CAS and ISS models).

The design environment software can then be used to add the extension component into a design, and then to build the design in the selected target implementation (VHDL, Verilog, CAS or ISS). The software can build the processor design with the extension in any language for which the extension has been provided. During the build process for the CAS and ISS, the C models are compiled to create a DLL or SO (shared object) model dependent on the target platform. This model can then be dynamically linked into the CAS or ISS processor models as appropriate.

Additionally, the aforementioned design environment (e.g., ARChitect) software can be configured to generate a customized version of the CAS adapted to the particular project being built by the user.

It will be recognized by those of ordinary skill that the foregoing techniques may be readily applied to other types of simulators as well.

Resultant Extension IP component

As previously discussed, upon completing the extension authoring and capture processes (here, implemented as a GUI-based routine such as a “wizard” of the type well known in the art) per FIG. 1, an IP component corresponding to the new component is created for placement in the IP Library (step 106). In the exemplary embodiment, the IP Component contains the automatically created extension IP based upon the parameters selected and the user's logic input. The structure of the component is made similar or identical to that of the host design environment (e.g., ARChitect); accordingly, the design software sees and presents the new extension component for use like any other component in the library. For example, a user may generate a Saturate-Add instruction extension. Upon running the aforementioned wizard, a Saturate-Add component will be created within the IP Library. The component viewer component within the ARChitect software then shows the Saturate-Add as an extension instruction.

In terms of the extension component created within the IP library, multiple forms are contemplated. For example, in a first embodiment (the so-called “minimal” configuration previously referenced), the extension references the extension component templates previously described. This form of extension can potentially be processor independent, since the templates can be specifically adapted to the target processor as discussed above. Each template comprises an individual IP component encapsulating the element it is templating—e.g. the ALU IP component will be the template for the ALU aspect of an extension. Each template will have a set of options that configure the IP—e.g. the ALU component may have an opcode value, an instruction mnemonic, number of cycles, etc. In one exemplary configuration, these templates are used in the way a normal IP Library component is used in a project. For example, if the user wishes to add a JTAG interface to a core, they would add it from the library to the project, and configure the options. Similarly, an ALU can be added into an extension component and then configured using the component options. The extension component software process uses this method when creating the extension for placement in the library. For every template component required, an instance of that component template can be created.

Referring again to FIG. 8, an exemplary extension component structure for use in the IP Library is shown. The component 802 (“MyNewExtension”) is a component in the IP library, with the extension structure 804 (“EI Parent Instance”). The extension component 802 contains references to 2 ALU instances 806, a core instance 808, and an auxiliary register instance 810, all contained within the extension structure 804. It is important to note that the component 802 (MyNewExtension) is an IP component definition in the IP Library, and that the structure (EI Parent Instance) and its children, ALU 806, CoreReg 808, and AuxReg 810 components, are component instances disposed therein. Upon adding the component 802 (MyNewExtension) into a project, the instance of the component is created as any other component, with the software tool's custom instance creation code being subsequently run, and the structure 804 copied into the component 802 thereby effectively creating the instance of the extension.

When a component is added to a project, an instance of the component can created in one of two ways. First, a method (e.g., “onCreate ( )”) of the component instantiation object (e.g., “ComponentInst”) is called. This method call creates a default component instance based upon the library component. Alternatively, if there is a custom event handler defined as part of the library component, its “onCreate ( )” method is called. In the exemplary embodiment, this event handler comprises computer code (e.g., Javascript) that is given complete control of the instance creation process, and is executed within the scope of the ComponentInst object. This latter method is preferentially used by extension tool of the present invention, since it allows for the performance of the special handling required for the copy operation described above with respect to FIG. 8.

As described above, the user logic (e.g., HDL and test code that are supplied by the user as additions to the standard template logic) must be captured and stored as part of the extension component within the library in the same way as files exist in the links of other IP components; e.g. vhdl files will be in the vhdl_child link. In the illustrated embodiment, each component (e.g., ALU) will add a single HDL file for each of the languages it targets, e.g. VHDL, Verilog, System C, etc. Each file is provided a corresponding filelist entry to permit merging it into the destination file.

In terms of test code, the illustrated embodiment optionally provides test code for each extension. One single file is created, and is also provided a corresponding file list operation to include it in the destination file set.

The foregoing approach requires the templates to be present when using the extension within a project. Accordingly, the present invention further contemplates template control, matching or update mechanisms whereby the current version of a template is verified before core build. This addresses potential issues wherein use of non-current templates may cause inconsistencies; e.g., where an extension is created and used (along with the templates) in a first build, and the templates change before the next build is performed, thereby causing the second build to be different although the extension in the library hasn't changed. In one embodiment, a template control mechanism is provided. For example, one such mechanism comprises providing the version number of the extension as a part of the library component; verification that the version number is incremented (either automatically from every change, or semi-automatically under the control of the user) is performed accordingly. When a design is created, the version of the component used is also already stored within the project. Therefore, the version in the project can be readily evaluated to determine if is up to date with the library (such as via the parent software of the design environment). Version numbers in the library and the project are both stored as XML in the exemplary embodiment, although it will be recognized that other languages or formats may be used.

In a second exemplary variant (“complete” variant), the extension authoring process builds a standalone IP component (as compared to the “reference” based embodiment previously described); in this approach, there is no dependency upon the templates, thereby advantageously allowing an instruction to be distributed without templates. The extension is structured and configured in the same manner as the aforementioned “minimal” solution, but rather than storing this structure in the library, a customized build of the extension is performed. The result of this process is that all template files are merged into the root extension file, which itself is included as an entry in the file list. Also, all data that is required to support the viewer modules associated with the design environment software; e.g. memory map, register map etc., is merged, and values fixed (based upon the option value specific to the template component). The resultant component is then placed in the IP Library.

It will be recognized that as the various ties to the extension templates are broken (such as by the user modifying the code). The extension generally loses compatibility with the software extension tool described herein. This may reduce the flexibility of the tool under certain circumstances, or potentially produce other undesired results. Accordingly, one exemplary solution to this issue is to place commented banners or other demarcations around one or more protected areas of the relevant HDL; this ensures that the HDL can be safely regenerated without destroying any user code. Other approaches (for protecting the user code) recognized by those of ordinary skill may optionally be used as well.

UI Management and Generation

The present invention also provides for dynamic user interface (UI) management and generation. Specifically, a significant feature of the UI (e.g., GUI) associated with the parent software design environment is that the GUI is generated dynamically based upon the templates driving the extension process. For example, in the context of the aforementioned ARChitect environment, the GUI does not require changes to any Java code to fix HDL issues, change displayed signals, and add options to the templates.

In the exemplary embodiment, the GUI is generated based upon the relevant extension templates to achieve a “capture” display. FIG. 4 shows an exemplary display 400 of this type. The four displayed tables (elements) of FIG. 4 represent the four elements of an exemplary extension (i.e., instruction, aux register, core register, and condition code) that are being automated by the templates and configured by the user. Each element is taken from an IP component template within the IP Library. For example, the “Instruction” element utilizes one or more templates from the IP library; e.g., the templates folder disposed therein. All extension templates reside under this folder. Similarly, the ALU IP Component utilizes templates from the library. A table is created to allow the user to add instances of an ALU to their extension. In the display 400 of FIG. 4, the “Instruction” element has two ALU instances represented in the rows of data. The first ALU instruction (instance) is the MULU instruction, comprising a 32-bit dual operand pipelined multi cycle extension which writes back result when finished.

The columnar data of the display 400 is derived from the template's standard set of options for the IP component. The ALU component, in the above example, has the following options: (i) Mnemonic, (ii) Code Size, (iii) Operands, (iv) Exe Cycles, (iv) Writeback, and (vi) Multi-Cycle Behavior. Each instance of an ALU component must provide values to these options.

In capturing the user logic, the signals available to the user to use within their extension are displayed. FIG. 5 shows one exemplary signal display configuration 500 provided by the design environment (ARChitect). Note that the same signals apply for each instruction at the top level of hierarchy within the extension, e.g. in the above example, the MULU, MULS and the top-level hierarchy module share the same signals.

In the exemplary embodiment, each IP component template specifies a number of signals. A signal is a data type implemented as an item of tool data stored within the IP component to which it relates. For example, the ALU template component will have a list of signals stored as XML code, the latter which will be read when populating the signal list for display in the GUI 500 along with the signals for any other used templates.

Within the GUI 500, a signal is considered as an item of data with properties as set forth in Table 21:

TABLE 21

| Field | Description |
|---|---|
| Signal Name | The name of the signal for display in the |
| | name field. This value may be a piece of |
| | JavaScript as the name may vary depending |
| | upon the instruction name. |
| Class | The class of the signal. Registered, |
| | Unregistered or constant. Here, the class |
| | of the signal refers to the supported |
| | signal types including Registered (signal |
| | in VHDL, reg in Verilog), Unregistered |
| | (signal in VHDL, wire in Verilog), |
| | Constant (constant in VHDL and parameter |
| | in Verilog), Integer (integer in Verilog, |
| | not used in VHDL), and user defined |
| | types in VHDL language. |
| Mode | The signal mode - internal, input or output |
| Bit Range | Number of bits used by the signal |
| Description | A description of the signal that can be |
| | used for a tooltip. This value is JavaScript |
| | as it may be specific to the conditions |
| | of the extension |
| Is Valid | JavaScript to determine if the signal will |
| | be included in the template wrappers signal |
| | declaration and should be queried for |
| | inclusion in the wizard. (The above GUI 1700 |
| | illustrates this) |
| Is Shown As | This JavaScript should be used to see if |
| Available | the signal is available to display as an |
| | available signal in the wizard. Some signals |
| | may be required to include in the templates |
| | but may not be appropriate for display in |
| | the GUI. |
| Is Shown As | If the signal is available (see above) then |
| Local | this JavaScript should be used to see if the |
| | signal is used in the local scope. Some |
| | signals may be included in the local scope by |
| | default. |

Referring again to FIG. 5, a user is able to add from the list of available signals 502 into the signals within the local scope 504. This addition maps to a signal declaration within the extension file that implements bringing the signal into the scope of the extension.

The above definition does not provide the functionality to allow the user to include signals in the local scope 504; it only allows the definition to specify those conditions in the “Is Shown As Local” field (data that is part of a signal definition of Table 21). Therefore, a list of all signals the user wishes to add must be maintained; if the signal of interest are included in this list, or the “Is Shown As Local” field returns a true value, the signal can be determined to be within the local scope.

The signal instance list is, in the illustrated embodiment, stored within the IP component definition within the IP Library. For example, FIG. 8 shows a component named MyNewExtension with two ALU instances 806; the signals list is stored within an XML or comparable language file at the MyNewExtension level.

In an alternate embodiment, all or a portion of the relevant signal names associated with the extension tool are abstracted so that they're human readable to at least some extent, or otherwise provide information regarding the signal, and correlated to the non-readable (non-informational) names. This abstraction advantageously makes the change between target processor technologies simpler, as the same signal names can be used to utilized with their corresponding processor-specific signal names.

This abstraction is also ideally documented (such as through use of a correlation table or other comparable mechanism). For example, the extension interface can use a set of generalized signals which are processor independent. An extension is integrated into the processor core by component instantiation where a lookup table is used for a specific processor to connect the processor-specific input/output signals to generalized input/output signals used by the extension in order to reduce the complexity of any debugging operations which may utilize these signal names.

Design Hierarchy Considerations

In the illustrated embodiment, design hierarchy is supported up to at least the first level within the extension software tool. Subsequent levels of hierarchy can be added manually using, e.g., the standard hierarchy support within the ARChitect design environment. However, it is further contemplated that support for the first hierarchy level may allow support of multiple (“n”) hierarchy levels. Hence, the illustrated embodiment provides both a manual addition option (since the user may wish to add complex HDL external to the extension tool), as well as an automated option suited for “internal” applications. These options are now described in greater detail.

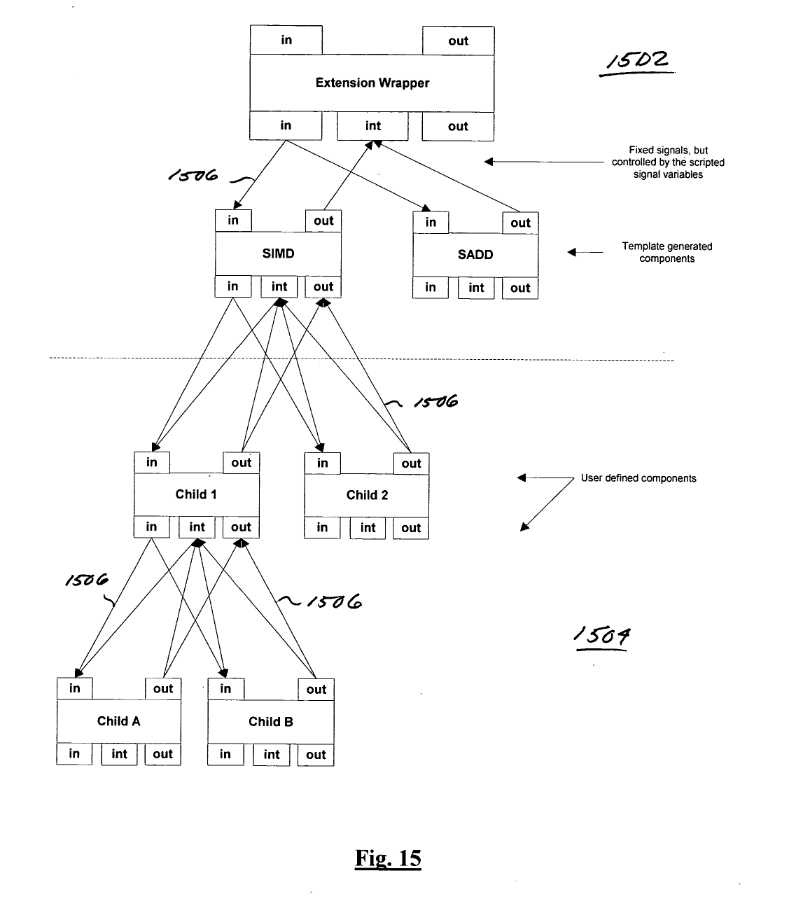

To provide for the automated creation of a hierarchy, the same information must be captured as for an ALU (discussed previously herein). A name for the block and its position within the hierarchy must also be provided. The name and signals allow creation of a port list, the component declaration (VHDL), and instantiation code. FIG. 15 demonstrates exemplary signal propagation through the components within the scope of the extension tool. FIG. 15 is used as a reference to populate the signal fields within the exemplary displays (FIG. 5) described above.

FIG. 15 contains two sections; the top section 1502 comprises the ALU level within the extension tool, while the bottom section 1504 adds the hierarchy. The arrows 1506 present in FIG. 15 indicate the source of the signal for the sake of the signal “hint” side of the extension tool. The signal hints need to propagate through the hierarchy; the arrows show this propagation and the signals that are available at any given point in the hierarchy.

The signal display for the top section 1502 of FIG. 15 is quite simple, as it is determined by the signal's scripted values. The bottom (hierarchy) section 1504, however, relies upon the user selecting a signal to which to couple their signal(s). In the context of FIG. 5, this relationship requires an added column in the local scope signal table 504 to identify the available signal(s) to which the local signal is coupled.

It is further noted that the extension techniques described herein may be applied to the design environment is varying degrees. For example, the present disclosure contemplates that only a select number or subset of all extensions which may be added to the core be added via the disclosed extension tool and associated methodologies. Alternatively, the extension tool and design environment may be configured such that any/all extensions are added via the extension tool. This latter configuration has the advantage of allowing identification those extensions that fall within the scope of a particular delivered feature list, and implementation of these features within the software tool. This allows for the provision of all related data and tools (e.g., test code, ISS models, HDL, regressions, etc.) in one unitary package, thereby providing a more comprehensive and easier-to-use solution for the designer.

It will also be recognized that while the exemplary embodiments of the present invention have been described in the context of less complex extensions, more complex extension features may be supported though the software tool (or alternatively IP authoring tools which may be provided with the design environment, or via third-party tools). For example, the following “complex” extension types may be implemented consistent with the invention: (i) user peripherals; (ii) user memory system/arbiter; (iii) direct memory interface (DMI) masters; and (iv) simulator versions of (i)-(iii). The present invention advantageously provides a starting point for development of these more complex extensions (see prior discussion of “complete” component description with reference to FIG. 1).

It can be appreciated that while certain aspects of the invention have been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1. A computerized processor design tool adapted to permit the addition of user-configured extensions useful across multiple heterogeneous target architectures.

2. The design tool of claim 1, wherein said extensions comprise abstracted language representations which each reference at least one native target architecture template.

3. The design tool of claim 2, wherein said abstracted language representations comprise XML definitions stored as components in a database.

4. A computerized processor design tool adapted to permit the addition of a user-configured extension, said tool being further adapted to provide variable levels of design abstraction.

5. The tool of claim 4, wherein said levels of abstraction comprise at least a high level of abstraction, wherein hardware associated with said extension is automatically implemented based on UT inputs from said user.

6. The tool of claim 5, wherein said levels of abstraction comprise at least an intermediate level of abstraction, wherein at least a first portion of said extension is implemented according to a UT definition, and a simplified extension interface is provided to said user to allow custom functionality to be created thereby.

7. The tool of claim 5, wherein said levels of abstraction comprise at least a low level of abstraction, wherein all internal signals associated with said extension are provided to said user via a UI, said UI allowing a complex extension to be created by said user.

8. A computerized tool for extending integrated circuit designs, comprising at least one abstracted and user-configured extension component definition rendered in a markup language, said component definition referencing at east one structure rendered in a native language.

9. The tool of claim 8, wherein said markup language comprises XML, and said structure comprises a template rendered in hardware description language.

10. The tool of claim 8, wherein said markup language comprises XML, and said structure comprises a template rendered in a behavioral language.

11. The tool of claim 10, wherein said tool is further adapted to operate within a computerized design environment.

12. A computerized tool adapted for use within a computerized design environment to automatically generate computer code useful in producing at least one extension, said tool being configured so that a user need only supply logic for said extension.

13. The tool of claim 12, wherein said at least one extension is selected from the group consisting of: (i) ALU extensions, (ii) core register extensions, (iii) auxiliary register extensions, and (iv) condition code extensions.

14. The tool of claim 13, wherein said design environment comprises an object oriented computerized environment.

15. The tool of claim 13, wherein said tool further comprises a database having a plurality of markup language extension definitions, said definitions each referencing at least one template.

16. The tool of claim 15, wherein said templates are rendered in a language native to a target architecture.

17. A method of generating an extension component for use with a computerized processor design, comprising:
selecting at least one extension type from a plurality of types, said at least on extension type comprising an extension definition rendered in a first language;
obtaining logic from a user regarding the desired functionality of said extension;
referencing at least one extension template rendered in a second language; and
generating said extension component based at least in part on said definition, user logic, and said at least one extension template.

18. The method of claim 17, further comprising storing said extension component with a database rendered substantially in said first language.

19. An extension component useful with a computerized design of a digital processor, comprising;
at least one extension template adapted to generate control logic for at least one extension type;
at least one extension test template adapted to permit testing of said extension component; and
user provided extension logic describing at least a portion of the functionality of said extension component.

20. The extension component of claim 19, further comprising:
user provided extension test code, and
component integration files.

21. The extension component of claim 19, wherein said control logic comprises control logic for instances of (i) extension ALUs, (ii) condition codes, and (iii) extension registers.

22. The extension component of claim 19, wherein said test templates are adapted to generate extension test code wrapper and compiler directives for the extension.

23. The extension component of claim 19, wherein said test templates comprise at least one extensions test placeholder template and at least one extension cross-reference template.

24. A method of generating an extension component for use with a computerized processor design, comprising:
selecting at least one extension type for use with said component;
selecting a plurality of configuration options associated with said at least one extension type;
generating at least one template based at least in part on said acts of selecting;
generating a custom interface based at least in part on said at least one template;
obtaining logic via said custom interface; and
combining said logic and said at least one template to produce said extension component.

25. The method of claim 24, further comprising storing said extension component in a markup language form within a database.

26. The method of claim 25, wherein said act of selecting comprises selecting from the group consisting of: (i) ALU extensions, (ii) core register extensions, (iii) auxiliary register extensions, and (iv) condition code extensions.

27. A computerized tool for extending integrated circuit designs, comprising at least one abstracted and configurable extension component definition rendered in a universal language, said component definition being adapted to reference at least individually a plurality of structures, said structures each rendered in a different native language.

28. The tool of claim 27, wherein at least one said structures is associated with a target architecture which does not yet exist.

29. The tool of claim 27, wherein said plurality of structures comprises a plurality of templates stored in a location different than that of said component definition.

30. The tool of claim 27, wherein at least one of said plurality of structures and said definition are bundled together to make a unitary library component specific to a target architecture.

31. A computerized tool for extending integrated circuit designs according to a plurality of different language implementations and architectural models, comprising:
a markup language database;
first data, common between said language implementations, abstracted into said database; and
a plurality of language-specific template interfaces corresponding to respective ones of said plurality of language implementations.

32. A method of doing business, comprising:
providing a design environment, and extension tool compatible with said design environment, to at least one customer; and
providing processor instructions to said at least one customers in a predetermined format, said format being adapted for use with said tool and design environment and further adapted to restrict said customer's selection of a particular parameter associated with said instruction(s) to those non-conflicting with ones of said parameters associated with pre-existing instructions.

33. The method of claim 32, wherein said act of providing processor instructions in a predetermined format comprises providing said instructions with predetermined or reserved opcodes.

34. A computerized tool adapted to efficiently extend integrated circuit designs, comprising at least one abstracted and configurable extension component definition rendered in a universal language, said component definition being adapted to generate support files.

35. The tool of claim 34, wherein said support files are selected from the group consisting of: (i) test hardware support files; test software support files; and (iii) assembler/compiler support files.

36. A computerized system for generating a processor design, comprising:
a computerized parent design environment;
an extension tool adapted to operate with said environment, said tool adapted to generate an extension component by:
selecting at least one extension type for use with said component;
selecting a plurality of configuration options associated with said at least one extension type;
generating at least one template based at least in part on said acts of selecting;
generating a user interface based at least in part on said at least one template;
obtaining logic via said user interface; and
combining said logic and said at least one template to produce said extension component.

37. The system of claim 36, wherein said design environment comprises an object oriented environment adapted to run on a computer.

38. The system of claim 37, wherein said at least one extension type comprises at least one of an ALU, condition code, auxiliary register, or core register.

39. The system of claim 38, wherein said extension component and said at least one template are rendered in a markup language.

40. The system of claim 39, further comprising a markup language database adapted to store at least one of said component and said template.

41. The system of claim 40, wherein said database further comprises (i) source code for said extension component, and (ii) data relating to the integration of said component with a processor design.
